(19) United States
(12) Patent Application Publication
(10) Pub. No.: US 2026/0313494 A1
(43) Pub. Date: Oct. 8, 2026

(54) NETWORK ENERGY SAVING FOR LAYER 1 OR LAYER 2 TRIGGERED MOBILITY

(71) Applicant: QUALCOMM Incorporated, San Diego, CA (US)

(72) Inventors: Qing LI, Princeton Junction, NJ (US); Navid ABEDINI, Basking Ridge, NJ (US); Jelena DAMNJANOVIC, Del Mar, CA (US); Junyi LI, Greentown, PA (US); Tao LUO, San Diego, CA (US)

(21) Appl. No.: 19/631,360

(22) Filed: Mar. 27, 2026

Related U.S. Application Data
(60) Provisional application No. 63/783,340, filed on Apr. 4, 2025.

(51) Int. Cl. H04W 36/04; H04W 36/00; H04W 52/02; H04W 56/00; H04W 74/0833

(52) U.S. Cl. CPC H04W 36/04; H04W 36/0058; H04W 52/0203; H04W 56/0015; H04W 74/0833

(57) ABSTRACT

Various aspects of the present disclosure generally relate to wireless communication. In some aspects, a user equipment (UE) may receive a network energy saving (NES) indication that indicates one or more NES parameters associated with one or more candidate network nodes for Layer 1 or Layer 2 (L1/L2) triggered mobility (LTM). The UE may communicate one or more messages with the one or more candidate network nodes in accordance with the one or more NES parameters as part of a synchronization procedure for LTM. The UE may transmit, to a serving network node, a measurement report in accordance with one or more measurements associated with the one or more candidate network nodes, wherein the one or more measurements are performed in accordance with the synchronization procedure and the one or more NES parameters. Numerous other aspects are described.

### CROSS-REFERENCE TO RELATED APPLICATION

This Patent Application claims priority to U.S. Provisional Patent Application No. 63/783,340, filed on Apr. 4, 2025, entitled “NETWORK ENERGY SAVING FOR LAYER 1 OR LAYER 2 TRIGGERED MOBILITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with network energy saving techniques for Layer 1 or Layer 2 triggered mobility procedures.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, a user equipment (UE) may be configured to perform Layer 1 or Layer 2 (L1/L2) triggered mobility (LTM) procedures (sometimes referred to as lower-layer triggered mobility). For example, the UE may be configured to perform measurements on one or more candidate cells (e.g., a candidate network node or distributed unit), and the UE may transmit a measurement report to a serving cell (e.g., a serving network node or serving central unit). In some examples, the network node may transmit an LTM cell switch command to initiate a cell switch procedure for the UE in accordance with signal quality, timing synchronization, or other parameters in the measurement report.

### SUMMARY

The systems, methods, and devices of this disclosure each have several innovative aspects, no single one of which is solely responsible for the desirable attributes disclosed herein.

In some cases, Layer 1 or Layer 2 triggered mobility (LTM) procedures may be impacted by changes at a network node associated with network energy savings (NES) techniques. For example, when a candidate network node of a user equipment (UE) enables discontinuous transmission techniques, the UE may be unable to perform measurements of or a pre-synchronization procedure (e.g., an uplink synchronization or pres-synchronization procedure, a downlink synchronization or pre-synchronization procedure) with the candidate network node if the UE attempts to measure during an off duration of the candidate network node. Additionally, or alternatively, the UE may be unable to monitor for an SSB or a channel state information reference signal (CSI-RS) (e.g., as part of LTM measurements or a pre-synchronization procedure) when the network node enables on-demand SSB or SSB adaptation techniques. In some cases, when the UE is to perform an LTM cell switch to the candidate network node, a random access attempt may be unsuccessful if the candidate network node has reduced a quantity of physical random access channel (PRACH) resources in accordance with NES techniques. Additionally, as the UE may be configured with a static configuration for LTM procedures, a serving network node of the UE may be unable to indicate updated information associated with NES procedures at the candidate network node.

Various aspects relate generally to supporting NES techniques with LTM procedures. Some aspects more specifically relate to supporting signaling of NES feature changes at a candidate network node to improve LTM procedures, including pre-synchronization, measurements, and LTM cell switch procedures, for a UE. In some aspects, the UE may be configured with one or more LTM candidate configurations associated with one or more NES feature configurations for one or more candidate network nodes. A serving network node of the UE may transmit a reconfiguration message (e.g., an RRC reconfiguration message) that reconfigures at least one LTM candidate configuration in accordance with one or more updates associated with the one or more NES feature configurations at a candidate network node. For example, the candidate network node may transmit, to another network node (e.g., the serving network node, or a different network node), an NES indication notification that indicates an update for an NES feature configuration at the candidate network node. In some aspects, the serving network node may transmit an NES indication to the UE that indicates one or more NES states (e.g., discontinuous reception (DRX) or discontinuous transmission (DTX) activated or deactivated, on-demand SSB activated or deactivated, or other states) or parameters (e.g., active duration of DTX or DRX, period of on-demand SSB, or other parameters) associated with the one or more candidate network nodes. For example, the NES indication may indicate an NES state such as an activation or deactivation state of one or more NES features at the candidate network node, such as a DTX or DRX activation or deactivation, an NES conditional handover activation or deactivation, an on-demand synchronization signal block (SSB) transmission indication or deactivation, an SSB adaptation indication, or a PRACH adaptation indication. The UE may be configured to perform pre-synchronization, LTM measurements, or LTM cell switch procedures in accordance with the NES indication.

Some aspects described herein relate to a UE. The UE may include a processing system. The processing system may include one or more processors and one or more code-storing memories coupled with the one or more processors. The processing system may be configured to cause the UE to receive a NES indication that indicates one or more NES parameters associated with one or more candidate network nodes for Layer 1 or Layer 2 triggered mobility (LTM). The processing system may be configured to cause the UE to communicate one or more messages with the one or more candidate network nodes in accordance with the one or more NES parameters as part of a synchronization procedure for LTM. The processing system may be configured to cause the UE to transmit, to a serving network node, a measurement report in accordance with one or more measurements associated with the one or more candidate network nodes, wherein the one or more measurements are performed in accordance with the synchronization procedure and the one or more NES parameters.

Some aspects described herein relate to a network node. The network node may include a processing system. The processing system may include one or more processors and one or more code-storing memories coupled with the one or more processors. The processing system may be configured to cause the network node to transmit, to a UE, an NES indication that indicates one or more NES parameters associated with one or more candidate network nodes for LTM. The processing system may be configured to cause the network node to receive, from the UE, a measurement report in accordance with one or more measurements associated with the one or more candidate network nodes, wherein the one or more measurements are performed in accordance with the one or more NES parameters.

Some aspects described herein relate to a method of wireless communication performed by a UE. The method may include receiving an NES indication that indicates one or more NES parameters associated with one or more candidate network nodes for LTM. The method may include communicating one or more messages with the one or more candidate network nodes in accordance with the one or more NES parameters as part of a synchronization procedure for LTM. The method may include transmitting, to a serving network node, a measurement report in accordance with one or more measurements associated with the one or more candidate network nodes, wherein the one or more measurements are performed in accordance with the synchronization procedure and the one or more NES parameters.

Some aspects described herein relate to a method of wireless communication performed by a network node. The method may include transmitting, to a UE, an NES indication that indicates one or more NES parameters associated with one or more candidate network nodes for LTM. The method may include receiving, from the UE, a measurement report in accordance with one or more measurements associated with the one or more candidate network nodes, wherein the one or more measurements are performed in accordance with the one or more NES parameters.

Some aspects described herein relate to a non-transitory computer-readable medium that stores a set of instructions for wireless communication by a UE. The set of instructions, when executed by one or more processors of the UE, may cause the UE to receive an NES indication that indicates one or more NES parameters associated with one or more candidate network nodes for LTM. The set of instructions, when executed by one or more processors of the UE, may cause the UE to communicate one or more messages with the one or more candidate network nodes in accordance with the one or more NES parameters as part of a synchronization procedure for LTM. The set of instructions, when executed by one or more processors of the UE, may cause the UE to transmit, to a serving network node, a measurement report in accordance with one or more measurements associated with the one or more candidate network nodes, wherein the one or more measurements are performed in accordance with the synchronization procedure and the one or more NES parameters.

Some aspects described herein relate to a non-transitory computer-readable medium that stores a set of instructions for wireless communication by a network node. The set of instructions, when executed by one or more processors of the network node, may cause the network node to transmit, to a UE, an NES indication that indicates one or more NES parameters associated with one or more candidate network nodes for LTM. The set of instructions, when executed by one or more processors of the network node, may cause the network node to receive, from the UE, a measurement report in accordance with one or more measurements associated with the one or more candidate network nodes, wherein the one or more measurements are performed in accordance with the one or more NES parameters.

Some aspects described herein relate to an apparatus for wireless communication. The apparatus may include means for receiving an NES indication that indicates one or more NES parameters associated with one or more candidate network nodes for LTM. The apparatus may include means for communicating one or more messages with the one or more candidate network nodes in accordance with the one or more NES parameters as part of a synchronization procedure for LTM. The apparatus may include means for transmitting, to a serving network node, a measurement report in accordance with one or more measurements associated with the one or more candidate network nodes, wherein the one or more measurements are performed in accordance with the synchronization procedure and the one or more NES parameters.

Some aspects described herein relate to an apparatus for wireless communication. The apparatus may include means for transmitting, to a UE, an NES indication that indicates one or more NES parameters associated with one or more candidate network nodes for LTM. The apparatus may include means for receiving, from the UE, a measurement report in accordance with one or more measurements associated with the one or more candidate network nodes, wherein the one or more measurements are performed in accordance with the one or more NES parameters.

Aspects of the present disclosure may generally be implemented by or as a method, apparatus, system, computer program product, non-transitory computer-readable medium, user equipment, network node, wireless communication device, or processing system as substantially described in the Detailed Description with respect to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of a Layer 1 or Layer 2 triggered mobility (LTM) procedure.

FIG. 3 is a diagram of an example associated with LTM candidate configurations updates for intra-central unit (CU) LTM.

FIG. 4 is a diagram of an example associated with LTM candidate configurations updates for inter-CU LTM.

FIG. 5 is a diagram of an example associated with synchronization procedures for intra-CU LTM.

FIG. 6 is a diagram of an example associated with synchronization procedures for inter-CU LTM.

FIG. 7 is a diagram of an example associated with LTM cell switching for intra-CU LTM.

FIG. 8 is a diagram of an example associated with LTM cell switching for inter-CU LTM.

FIG. 9 is a diagram illustrating an example process performed, for example, at a user equipment (UE) or an apparatus of a UE.

FIG. 10 is a diagram illustrating an example process performed, for example, at a first network node or an apparatus of a first network node.

FIG. 11 is a diagram of an example apparatus for wireless communication.

FIG. 12 is a diagram of an example apparatus for wireless communication.

### DETAILED DESCRIPTION

In some wireless communication systems, a user equipment (UE) may be configured to perform Layer 1 or Layer 2 (L1/L2) triggered mobility (LTM) procedures (sometimes referred to as lower-layer triggered mobility). For example, the UE may be configured to perform measurements on one or more candidate cells (e.g., a candidate network node or central unit (CU)), and the UE may transmit a measurement report to a serving cell (e.g., a serving network node). In some examples, the network node may transmit an LTM cell switch command via L1/L2 signaling to initiate a cell switch procedure for the UE in accordance with signal quality, timing synchronization, or other parameters in the measurement report. By signaling the LTM cell switch command using L1/L2 signaling, LTM procedures may allow for higher-layer (e.g., Layer 3 or higher) configurations for the UE to be maintained, thereby allowing for faster and more efficient cell switching with reduced handover latency relative to non LTM handover procedures (e.g., radio resource control (RRC)-signaled cell switching).

In some examples, network energy saving (NES) techniques may be used in some wireless communication systems to enhance energy efficiency and reduce power consumption across network devices. For example, a network node may be configured to perform discontinuous transmission (DTX) or discontinuous reception (DRX) techniques, which may allow the network node to enter low-power states during periods of inactivity, and only transmitting or receiving during an on duration (e.g., an active duration). Additionally, or alternatively, the network node may be configured to perform on-demand synchronization signal block (SSB) or SSB adaptation techniques, where the network node may save power by reducing a frequency or duration of SSBs based on network conditions and demand. Additionally, or alternatively, the network node may be configured to perform physical random access channel (PRACH) adaptation techniques, where the network node may adjust resource allocation for random access procedures, ensuring efficient use of available resources and reducing resources when demand for random access communications is low to save power. By dynamically managing these features, NES techniques may help reduce energy consumption while maintaining network performance and user experience.

In some cases, however, LTM procedures may be impacted by changes at a network node associated with NES techniques. For example, when a candidate network node of the UE enables discontinuous transmission techniques, the UE may be unable to perform measurements of or a pre-synchronization procedure (e.g., an uplink synchronization or a downlink synchronization) with the candidate network node if the UE attempts to measure during an off duration of the candidate network node. Additionally, or alternatively, the UE may be unable to monitor for an SSB or a channel state information reference signal (CSI-RS) (e.g., as part of LTM measurements or a pre-synchronization procedure) when the network node enables on-demand SSB or SSB adaptation techniques. In some cases, when the UE is to perform an LTM cell switch to the candidate network node, a random access attempt may be unsuccessful if the candidate network node has reduced a quantity of PRACH resources in accordance with NES techniques. Additionally, as the UE may be configured with a static configuration for LTM procedures (e.g., via RRC signaling), a serving network node of the UE may be unable to indicate updated information associated with NES procedures at the candidate network node.

Various aspects relate generally to supporting NES techniques with LTM procedures. Some aspects more specifically relate to supporting signaling of NES feature changes at a candidate network node to improve LTM procedures, including pre-synchronization, measurements, and LTM cell switch procedures, for a UE. In some aspects, the UE may be configured with one or more LTM candidate configurations associated with one or more NES feature configurations for one or more candidate network nodes. A serving network node of the UE may transmit a reconfiguration message (e.g., an RRC reconfiguration message) that reconfigures at least one LTM candidate configuration in accordance with one or more updates associated with the one or more NES feature configurations at a candidate network node. For example, the candidate network node may transmit, to another network node (e.g., the serving network node, or a different network node), an NES indication notification that indicates an update for an NES feature configuration at the candidate network node. In some aspects, the serving network node may transmit an NES indication to the UE that indicates one or more NES states (e.g., DTX or DRX activated or deactivated, on-demand SSB activated or deactivated, or other states) or parameters (e.g., active duration of DTX or DRX, period of on-demand SSB, or other parameters) associated with the one or more candidate network nodes. For example, the NES indication may indicate an NES state such as an activation or deactivation state of one or more NES features at the candidate network node, such as a DTX or DRX activation or deactivation, an NES conditional handover activation or deactivation, an on-demand SSB transmission indication or deactivation, an SSB adaptation indication, or a PRACH adaptation indication. The UE may be configured to perform pre-synchronization, LTM measurements, or LTM cell switch procedures in accordance with the NES indication.

Particular aspects of the subject matter described in this disclosure can be implemented to realize one or more of the following potential advantages. In some examples, the described techniques can be used to support LTM procedures while enabling NES features for one or more candidate cells of a UE. By supporting signaling of NES feature changes at candidate network nodes, the system can dynamically adapt to varying network conditions, thereby enhancing overall efficiency and performance. Additionally, by configuring a serving network node to transmit reconfiguration messages that update LTM candidate configurations at the UE, the UE may be able to continue performing LTM procedures such as pre-synchronization, measurements, or LTM cell switching with a candidate network node even as the candidate network node adjusts communication parameters in accordance with NES feature updates. For example, the UE may receive the NES indication and may perform LTM procedures in accordance with the NES indication, which may enable the UE to perform LTM procedures while supporting reduced energy consumption at candidate network nodes. Accordingly, these techniques may contribute to a more sustainable and efficient wireless communication system, capable of meeting the growing demands for connectivity while minimizing energy consumption and operational costs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, NES, low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

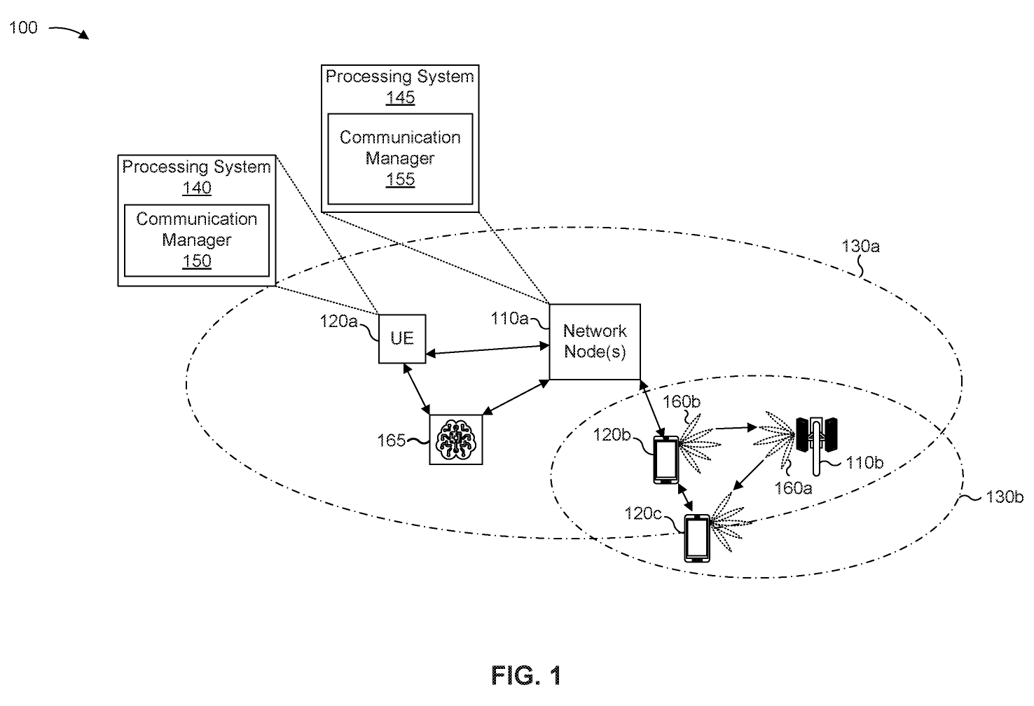

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more CUs, one or more DUs, and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120amay perform codebook-based precoding or non-codebook-based precoding. Codebook-based precoding may involve selecting a precoder (for example, a precoding matrix) using a codebook. For example, the network node 110amay provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110aor the UE 120amay transmit the processed downlink or uplink signals, respectively, via one or more antennas.

The network node 110a or the UE 120a may receive uplink signals or downlink signals, respectively, via one or more antennas. The network node 110aor the UE 120a(for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110aor the UE 120a(for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive an NES indication that indicates one or more NES parameters associated with one or more candidate network nodes 110 for LTM; communicate one or more messages with the one or more candidate network nodes 110 in accordance with the one or more NES parameters as part of a synchronization procedure for LTM; and transmit, to a serving network node 110, a measurement report in accordance with one or more measurements associated with the one or more candidate network nodes 110, wherein the one or more measurements are performed in accordance with the synchronization procedure and the one or more NES parameters. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, an NES indication that indicates one or more NES parameters associated with one or more candidate network nodes 110 for LTM; and receive, from the UE 120, a measurement report in accordance with one or more measurements associated with the one or more candidate network nodes 110, wherein the one or more measurements are performed in accordance with the one or more NES parameters. Additionally, or alternatively, the communication manager 155 may perform one or more other operations described herein.

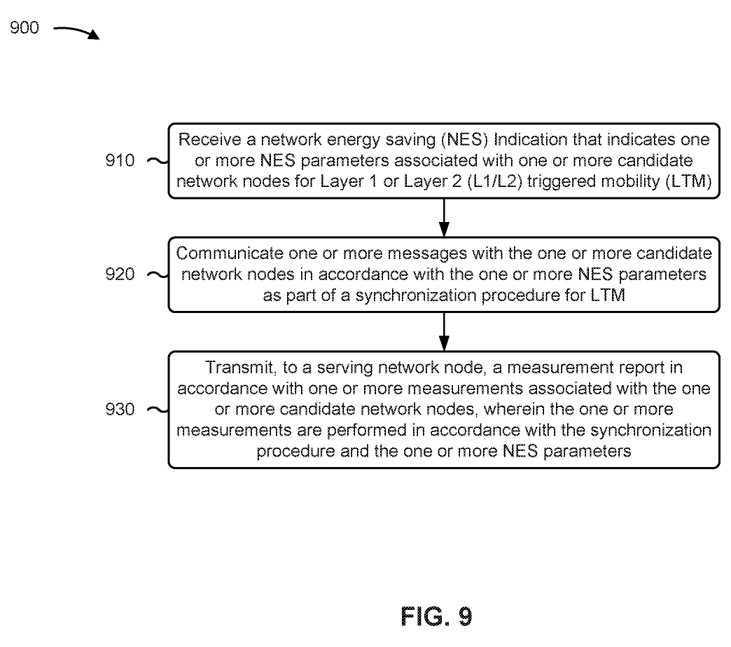

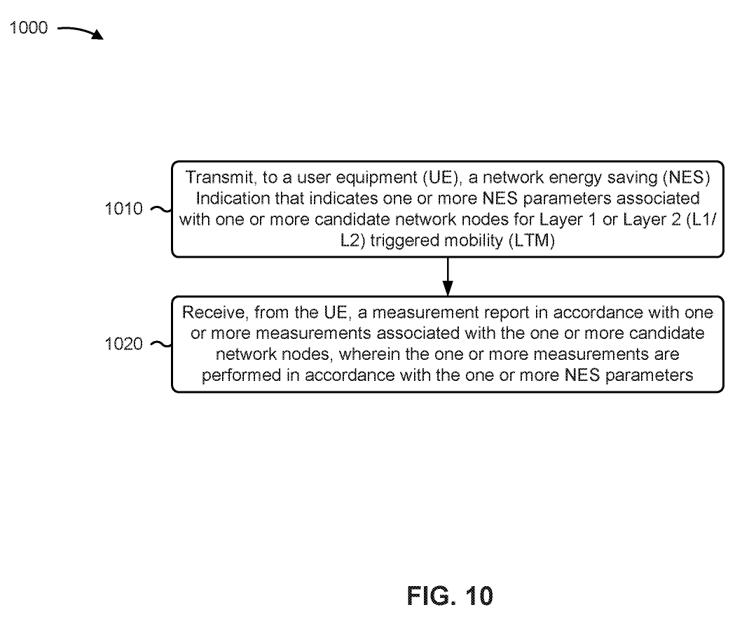

The network node 110, the processing system 145 of the network node 110, the UE 120, the processing system 140 of the UE 120, or any other component(s) of FIG. 1 may implement one or more techniques or perform one or more operations associated with supporting NES techniques for LTM procedures, as described in more detail elsewhere herein. For example, the processing system 145 of the network node 110, or the processing system 140 of the UE 120 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

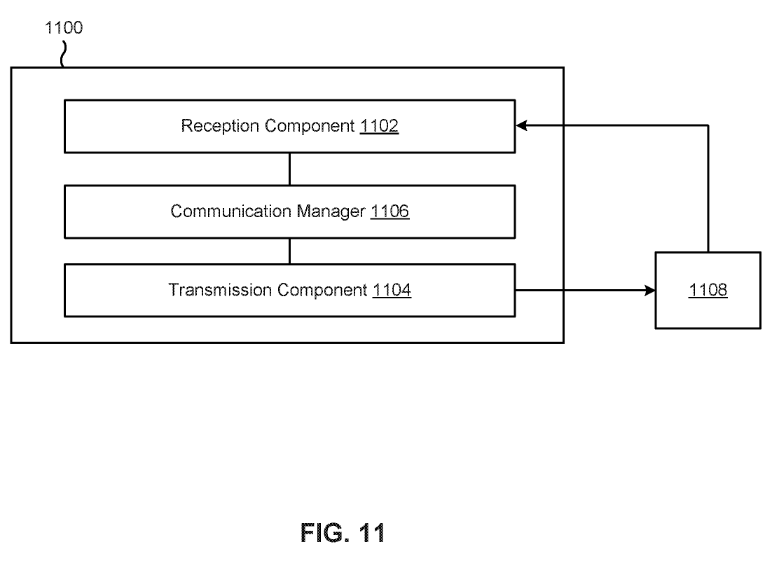

In some aspects, the UE includes means for receiving an NES indication that indicates one or more NES parameters associated with one or more candidate network nodes for LTM; means for communicating one or more messages with the one or more candidate network nodes in accordance with the one or more NES parameters as part of a synchronization procedure for LTM; or means for transmitting, to a serving network node, a measurement report in accordance with one or more measurements associated with the one or more candidate network nodes, wherein the one or more measurements are performed in accordance with the synchronization procedure and the one or more NES parameters. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

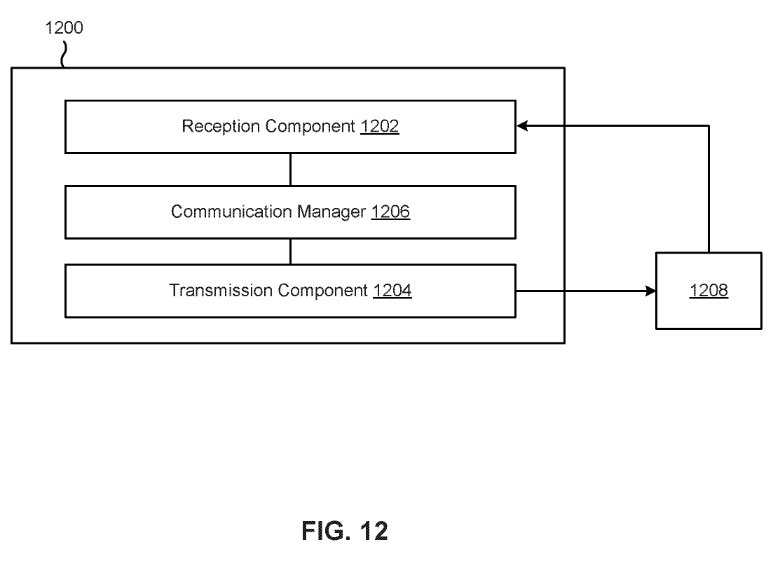

In some aspects, the first network node includes means for transmitting, to a UE, an NES indication that indicates one or more NES parameters associated with one or more candidate network nodes for LTM; or means for receiving, from the UE, a measurement report in accordance with one or more measurements associated with the one or more candidate network nodes, wherein the one or more measurements are performed in accordance with the one or more NES parameters. The means for the first network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 13), among other examples.

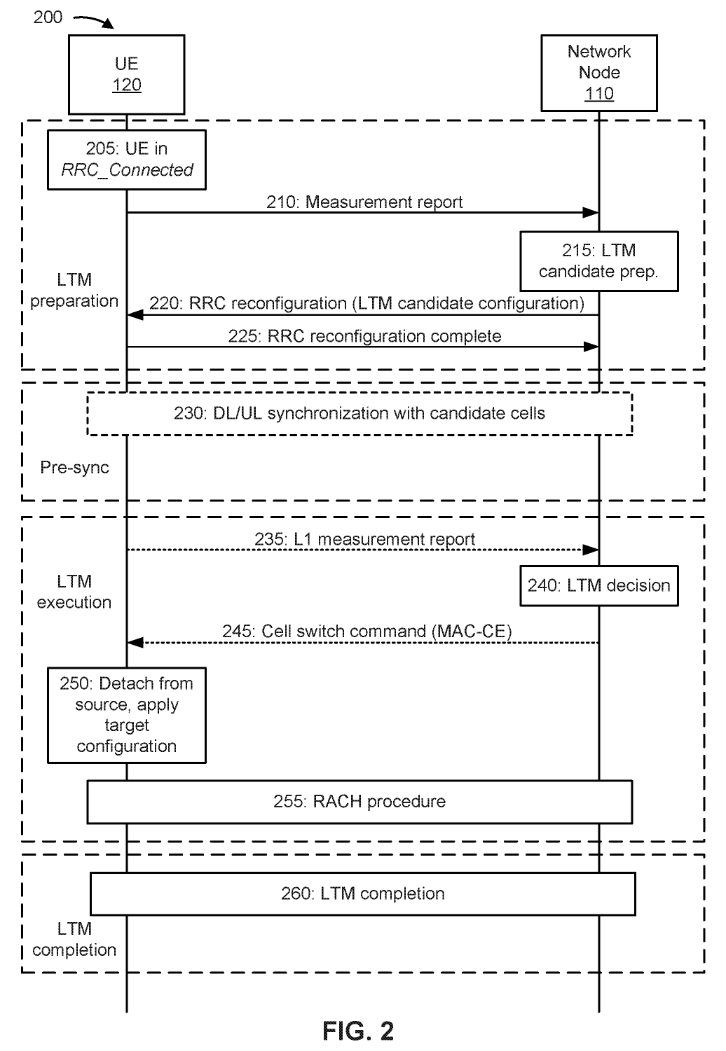

FIG. 2 is a diagram illustrating an example 200 of an LTM procedure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using a layer 3 (L3) handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages or other L3 signaling and operations used to perform the handover procedures. Accordingly, in some examples, a UE 120 may be configured to perform an LTM procedure, sometimes referred to as a lower-layer (e.g., L1/L2) handover procedure, such as the example 200 LTM procedure shown in FIG. 2. As shown in FIG. 2, the LTM procedure may include four phases: an LTM preparation phase, a pre-synchronization phase (shown as “pre-sync” in FIG. 2, also known as an early synchronization phase), an LTM execution phase, an LTM execution cell switch phase, an LTM completion phase, or an LTM cell switch completion phase.

During the LTM preparation phase, and as shown by reference number 205, the UE 120 may be in an RRC connected state (sometimes referred to as RRC_Connected) with a source cell. As shown by reference number 210, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, or CQI) or similar measurements associated with the source cell or one or more neighboring cells. In some examples, based at least in part on the measurement report or other information, the network node 110 may decide to use LTM, and thus, as shown by reference number 215, the network node 110 may initiate LTM candidate preparation.

As shown by reference number 220, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE or cells for which the UE 120 may later be triggered to perform an LTM procedure. As shown by reference number 225, the UE 120 may store the configuration of the one or more LTM candidate cell configurations and, in response, may transmit, to the network node 110, an RRC reconfiguration complete message (sometimes referred to as an RRCReconfigurationComplete message).

During the pre-synchronization phase, and as shown by reference number 230, the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with reference number 245). In some aspects, performing the pre-synchronization with the one or more candidate cells may reduce latency associated with performing a random access channel (RACH) procedure later in the LTM procedure, which is described in more detail below in connection with reference number 255.

During the LTM execution phase, and as shown by reference number 235, the UE 120 may perform L1 measurements on the configured LTM candidate target cells, and thus may transmit, to the network node 110, lower-layer (e.g., L1) measurement reports. As shown by reference number 240, based at least in part on the lower-layer measurement reports, the network node 110 may decide to execute an LTM cell switch to a target cell. Accordingly, as shown by reference number 245, the network node 110 may transmit, and the UE 120 may receive, a MAC-CE or similar message triggering an LTM cell switch (the MAC-CE or similar message is sometimes referred to herein as a cell switch command). The cell switch command may include an indication of a candidate configuration index associated with the target cell. As shown by reference number 250, based at least in part on receiving the cell switch command, the UE 120 may switch to the configuration of the LTM candidate target cell (e.g., the UE 120 may detach from the source cell and apply the target cell configuration). Moreover, as shown by reference number 255, the UE 120 may perform a RACH procedure towards the target cell, such as when a timing advance associated with the target cell is not available (e.g., in examples in which the UE 120 did not perform the pre-synchronization as described above in connection with reference number 230).

During the LTM completion phase, and as shown by reference number 260, the UE 120 may indicate successful completion of the LTM cell switch towards the target cell. In this way, cell switch to a target cell may be performed using less overhead than for an L3 handover procedure or a cell switch to a target cell may be associated with reduced latency relative to the L3 handover procedure.

In some aspects, the example 200 may support LTM procedures while enabling NES feature changes at one or more candidate cells. In some examples, the UE 120 may be configured with one or more LTM candidate configurations associated with one or more NES feature configurations for one or more candidate cells. In some aspects, a serving cell of the UE 120 may transmit a reconfiguration message (e.g., an RRC reconfiguration message) that reconfigures at least one LTM candidate configuration in accordance with one or more updates associated with the one or more NES feature configurations at a candidate cell. For example, the candidate cell may transmit, to a network node 110 (e.g., a serving DU or a candidate DU), an NES indication notification that indicates an update for an NES feature configuration at the candidate cell. In some aspects, the serving cell may transmit an NES indication to the UE 120 that indicates one or more NES parameters associated with the one or more candidate network nodes. For example, the NES indication may indicate an activation or deactivation one or more NES features at the candidate cell, such as a DTX or DRX activation or deactivation, an NES conditional handover, an on-demand SSB transmission indication or deactivation, an SSB adaptation indication, or a PRACH adaptation indication. The UE 120 may be configured to perform pre-synchronization, LTM measurements, or LTM cell switch procedures in accordance with the NES indication.

As indicated above, FIG. 2 is provided as an example. Other examples may differ from what is described with respect to FIG. 2.

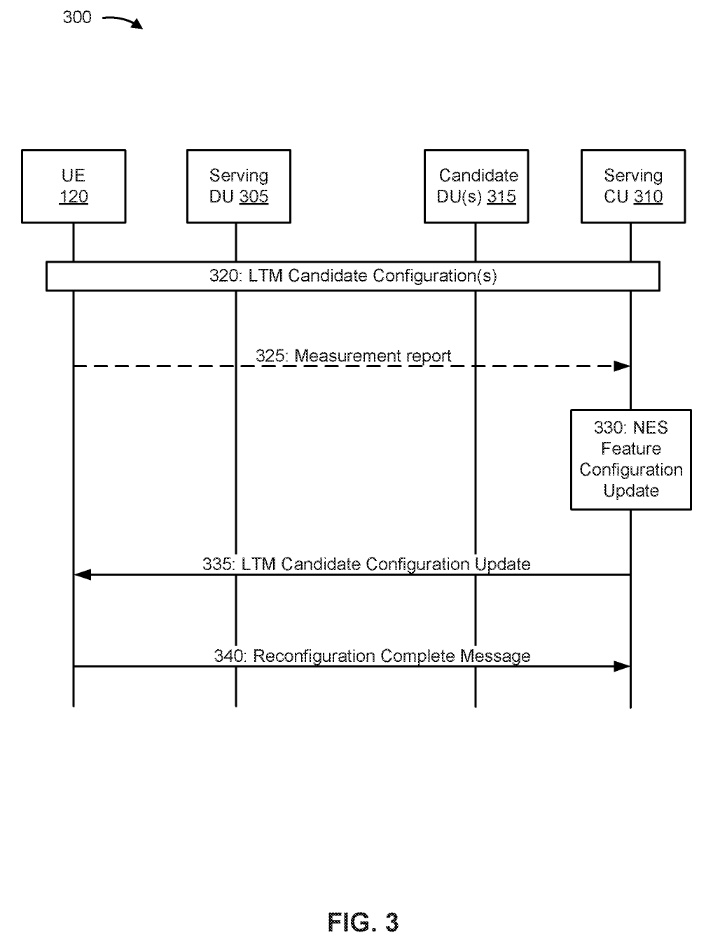

FIG. 3 is a diagram of an example 300 associated with LTM candidate configurations updates for intra-CU LTM. The example 300 illustrates communications between a UE 120, a serving DU 305 (or source DU), a serving CU 310 (or source CU) associated with the serving DU 305, and one or more candidate DUs 315 (or target DUs) associated with the serving CU 310. The serving DU 305, the serving CU 310, and the one or more candidate DUs 315 may be examples of one or more network nodes 110, and operations attributed to the serving DU 305, the serving CU 310, or the one or more candidate DUs 315 may instead be performed by one or more network nodes 110 such as one or more CUs, one or more DUs, one or more RUs, one or more core network nodes, one or more network servers, one or more application servers, or one or more Access and Mobility Management Functions (AMFs), among other examples. The example 300 may correspond to procedures associated with an LTM preparation phase, as described with respect to FIG. 2.

As shown by reference number 320, the UE 120 may be configured with one or more LTM candidate configurations. In some examples, the UE 120 may receive the one or more LTM candidate configurations from the serving DU 305, and the one or more LTM candidate configurations may configure or otherwise be in accordance with communications between the UE 120, the serving DU 305, the one or more candidate DUs 315, the serving CU 310, or any combination thereof.

In some aspects, the one or more LTM candidate configurations may include or indicate one or more NES feature configurations associated with one or more NES features supported or implemented by the one or more candidate DUs 315. For example, the one or more NES feature configurations may include a DTX configuration (e.g., one or more starting times of active transmitting state, one or more durations of active transmitting state, one or more DTX cycles, one or more conditions of activating or deactivating the DTX, or other parameters), a DRX configuration (e.g., one or more starting times of active receiving state, one or more durations of active receiving state, one or more DRX cycles, one or more conditions of activating or deactivating the DRX or other parameters), an NES conditional handover configuration (e.g., one or more conditions for NES conditional handover mode, or other parameters), an on-demand SSB configuration (e.g., one or more periods, one or more time and frequency allocations, one or more numbers for on-demand SSB bursts, or other parameters), an SSB adaptation configuration (e.g., one or more periods, one or more time and frequency allocations, one or more durations of the adaptation, or other parameters), a PRACH adaptation configuration (e.g., one or more additional PRACH occasions (including time and frequency resources), one or more durations of the adaptation, or other parameters), or another NES feature configuration associated with the one or more candidate DUs 315.

Additionally, or alternatively, the one or more LTM candidate configurations may configure the UE 120 to monitor for NES indications (also referred to as NES feature indications) from the serving DU 305, the one or more candidate DUs 315, or a combination thereof. For example, the one or more LTM candidate configurations may configure the UE 120 to monitor for NES indications via a common search space (CSS) of a control resource set (CORESET) configured for at least one candidate DU 315. In some aspects, the at least one candidate DU 315 may transmit an NES indication associated with the one or more NES feature configurations via the CSS, and the NES indication may be transmitted in accordance with an identifier (e.g., a radio network temporary identifier (RNTI), such as an RNTI specific to NES indication or NES indication). In some examples, the identifier may be configured via the one or more LTM candidate configurations, and the UE 120 may receive the NES indication in accordance with the identifier (e.g., the identifier may be used for scrambling of the NES indication or NES indication (e.g., DCI or MAC-CE pointed by the DCI)), and the UE 120 may descramble the NES indication using the identifier (e.g., descramble the DCI carrying the indication or descramble the DCI pointing to the MAC-CE carrying the indication).

As shown by reference number 325, the UE 120 may transmit, to the serving CU 310, a measurement report (e.g., an L1 measurement report). For example, the UE 120 may transmit the measurement report in accordance with one or more measurements associated with the one or more candidate DUs 315. In some aspects, the one or more measurements may be performed in accordance with the one or more LTM candidate configurations. For example, the UE 120 may measure one or more SSBs or CSI-RSs in accordance with the one or more NES feature configurations (e.g., based on the DTX, on-demand SSB, or SSB adaptation).

As shown by reference number 330, the serving CU 310 may determine an update for the one or more NES feature configurations. For example, the serving CU 310 may determine to update or activate an NES feature for a serving cell or a candidate LTM cell associated with the serving DU 305 or at least one candidate DU 315. In some examples, the determination to update the one or more NES feature configurations may be performed based on one or more measurement reports received from the UE 120, cell loading status associated with the at least one candidate DU 315 or the serving DU 305 (e.g., a traffic load), energy saving procedures (e.g., to reduce energy consumption at the at least one candidate DU 315 or the serving DU 305), or other conditions.

In some aspects, the serving CU 310 may communicate, to at least one candidate DU 315 or the serving DU 305, an indication of an update for the one or more NES feature configurations. In some examples, the update for the one or more NES feature configurations may include at least one of an activation, deactivation, or reconfiguration (e.g., RRC reconfiguration) for a DTX configuration or a DRX configuration, a reconfiguration (e.g., RRC reconfiguration) for an on-demand SSB transmission configuration or transmissions with or without always-on SSB, a reconfiguration (e.g., an RRC reconfiguration) for an SSB adaptation (e.g., a reconfiguration or adaptation to one or more periods for SSB transmission), or an adaptation or reconfiguration (e.g., RRC reconfiguration) for a PRACH adaptation configuration (e.g., to configure additional RACH occasions in time or frequency, or to reduce a quantity of RACH occasions). In some aspects, the update for the one or more NES feature configurations may be indicated via a MAC-CE or a DCI (e.g., for activation or deactivation) or via RRC signaling (e.g., for updates or reconfigurations, such as RRC reconfiguration).

As shown by reference number 335, the serving CU 310 may update the one or more LTM candidate configurations for the UE 120. For example, the serving CU 310 may reconfigure (e.g., via an RRC reconfiguration message) the one or more LTM candidate configurations in accordance with updates, activations, or deactivations associated with the one or more NES feature configurations for the one or more candidate DUs 315 or the serving DU 305. Additionally, or alternatively, the serving CU 310 may update a configuration for monitoring for NES indications from the serving DU 305 or the one or more candidate DUs 315. Accordingly, the UE 120 may be configured to monitor for NES indications in accordance with a current NES feature configuration for the serving DU 305 or the one or more candidate DUs 315, which may ensure the UE 120 is able to monitor for measurements, SSBs, or NES indications during occasions that are configured for transmission of reference signals, SSBs, or NES indications.

As shown by reference number 340, the UE 120 may transmit, to the serving CU 310, a reconfiguration complete message (e.g., an RRC reconfiguration complete message). For example, the reconfiguration complete message may indicate that the update to the one or more LTM candidate configurations was successful.

As indicated above, FIG. 3 is provided as an example. Other examples may differ from what is described with respect to FIG. 3. For example, some steps shown in the example 300 may be omitted, performed in a different order than shown, or performed by different devices. Additionally, or alternatively, additional steps not shown may be performed.

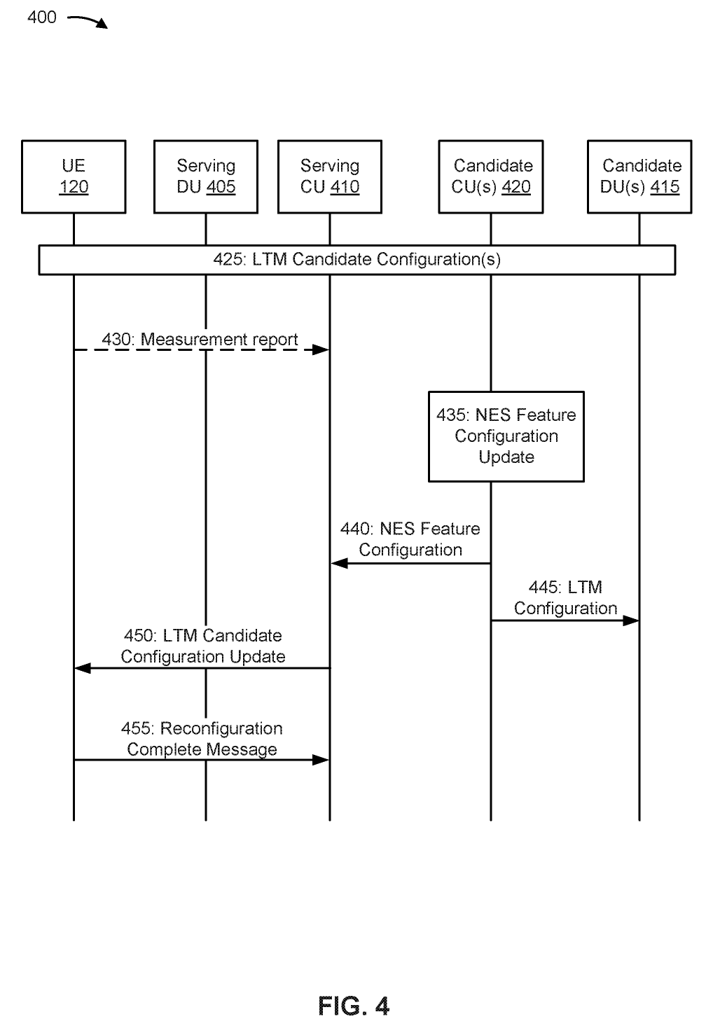

FIG. 4 is a diagram of an example 400 associated with LTM candidate configurations updates for inter-CU LTM. The example 400 illustrates communications between a UE 120, a serving DU 405 (or source DU), a serving CU 410 (or source CU) associated with the serving DU 405, and one or more candidate DUs 415 (or target DUs), and one or more candidate CUs 420 associated with the one or more candidate DUs 415. The serving DU 405, the serving CU 410, the one or more candidate DUs 415, and the one or more candidate CUs 420 may be examples of one or more network nodes 110, and operations attributed to the serving DU 405, the serving CU 410, the one or more candidate DUs 415, or the one or more candidate CUs 420 may instead be performed by one or more network nodes 110 such as one or more CUs, one or more DUs, one or more RUs, one or more core network nodes, one or more network servers, one or more application servers, or one or more AMFs, among other examples.

The example 400 may correspond to an example where the serving DU 405 is associated with communications with the serving CU 410, but the one or more candidate DUs 415 are associated with communications with one or more candidate CUs 420 that may be different from the serving CU 410. Accordingly, the example 400 may correspond to inter-CU LTM procedures. The example 400 may correspond to procedures associated with an LTM preparation phase, as described with respect to FIG. 2.

As shown by reference number 425, the UE 120 may be configured with one or more LTM candidate configurations, as described herein. In some examples, the UE 120 may receive the one or more LTM candidate configurations from the serving DU 405, and the one or more LTM candidate configurations may configure or otherwise be in accordance with communications between the UE 120, the serving DU 405, the one or more candidate DUs 415, the serving CU 410, the one or more candidate CUs 420, or any combination thereof. In some aspects, the one or more LTM candidate configurations may include or indicate one or more NES feature configurations associated with one or more NES features supported or implemented by the one or more candidate DUs 415, as described herein. Additionally, or alternatively, the one or more LTM candidate configurations may configure the UE 120 to monitor for NES indications from the serving DU 405, the one or more candidate DUs 415, or a combination thereof, as described herein.

As shown by reference number 430, the UE 120 may transmit, to the serving CU 410, a measurement report (e.g., an L1 measurement report). For example, the UE 120 may transmit the measurement report in accordance with one or more measurements associated with the one or more candidate DUs 415. In some aspects, the one or more measurements may be performed in accordance with the one or more LTM candidate configurations. For example, the UE 120 may measure one or more SSBs or CSI-RSs in accordance with the one or more NES feature configurations.

As shown by reference number 435, the one or more candidate CUs 420 may determine an update for the one or more NES feature configurations. For example, the one or more candidate CUs 420 may determine to update or activate an NES feature for at least one candidate DU 415. In some examples, the determination to update the one or more NES feature configurations may be performed based on one or more measurement reports received from the UE 120 (e.g., received via the serving CU 410 and forwarded to the one or more candidate CUs 420), cell loading status associated with the at least one candidate DU 415 (e.g., a traffic load), energy saving procedures (e.g., to reduce energy consumption at the at least one candidate DU 415), or other conditions.

In some examples, the update for the one or more NES feature configurations may include at least one of an activation, deactivation, or reconfiguration (e.g., RRC reconfiguration) for a DTX configuration or a DRX configuration, a reconfiguration (e.g., RRC reconfiguration) for an on-demand SSB transmission configuration or transmissions with or without always-on SSB, a reconfiguration (e.g., an RRC reconfiguration) for an SSB adaptation (e.g., a reconfiguration or adaptation to one or more periods for SSB transmission), or an adaptation or reconfiguration (e.g., RRC reconfiguration) for a PRACH adaptation configuration (e.g., to configure additional RACH occasions in time or frequency, or to reduce a quantity of RACH occasions).

As shown by reference number 440, the one or more candidate CUs 420 may transmit, to the serving CU 410, an indication of the one or more NES feature configurations (e.g., of an update for the one or more NES feature configurations). For example, the one or more candidate CUs 420 may transmit an indication of any updates, activations, or deactivations associated with the one or more NES feature configurations to the serving CU 410.

As shown by reference number 445, the one or more candidate CUs 420 may communicate, to the one or more candidate DUs 415, an indication of an update (e.g., activation, deactivation, or reconfiguration) for the one or more NES feature configurations. In some aspects, the update for the one or more NES feature configurations may be indicated via a MAC-CE or a DCI (e.g., for activation or deactivation) or via RRC signaling (e.g., for updates or reconfigurations, such as RRC reconfiguration).

As shown by reference number 450, the serving CU 410 may update the one or more LTM candidate configurations for the UE 120 in accordance with receiving the indication of the one or more NES feature configurations from the one or more LTM candidate cells (e.g., associated with the one or more candidate CUs 420). For example, the serving CU 410 may reconfigure (e.g., via an RRC reconfiguration message) the one or more LTM candidate configurations in accordance with updates, activations, or deactivations associated with the one or more NES feature configurations for the one or more candidate DUs 415. Additionally, or alternatively, the serving CU 410 may update a configuration for monitoring for NES indications from the one or more candidate DUs 415. Accordingly, the UE 120 may be configured to monitor for NES indications in accordance with a current NES feature configuration for the one or more candidate DUs 415, even when the one or more candidate DUs 415 are associated with a different CU from the serving CU 410.

As shown by reference number 455, the UE 120 may transmit, to the serving CU 410, a reconfiguration complete message (e.g., an RRC reconfiguration complete message). For example, the reconfiguration complete message may indicate that the update to the one or more LTM candidate configurations was successful.

As indicated above, FIG. 4 is provided as an example. Other examples may differ from what is described with respect to FIG. 4. For example, some steps shown in the example 400 may be omitted, performed in a different order than shown, or performed by different devices. Additionally, or alternatively, additional steps not shown may be performed.

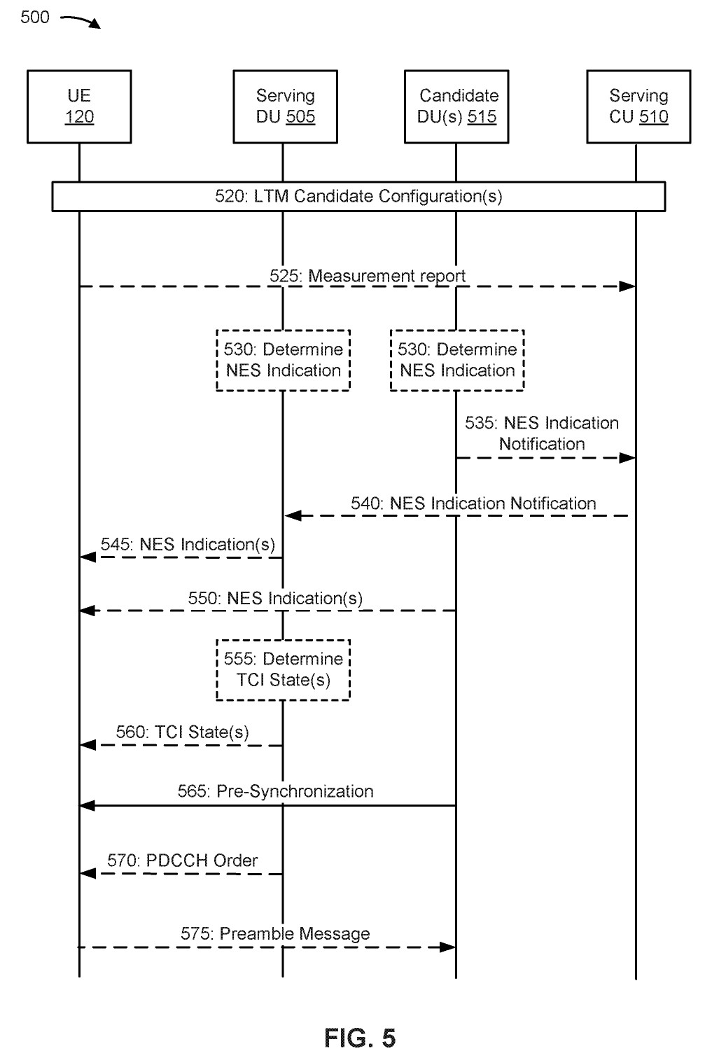

FIG. 5 is a diagram of an example 500 associated with synchronization procedures for intra-CU LTM. The example 500 illustrates communications between a UE 120, a serving DU 505 (or source DU), a serving CU 510 (or source CU) associated with the serving DU 505, and one or more candidate DUs 515 (or target DUs) associated with the serving CU 510. The serving DU 505, the serving CU 510, and the one or more candidate DUs 515 may be examples of one or more network nodes 110, and operations attributed to the serving DU 505, the serving CU 510, or the one or more candidate DUs 515 may instead be performed by one or more network nodes 110 such as one or more CUs, one or more DUs, one or more RUs, one or more core network nodes, one or more network servers, one or more application servers, or one or more AMFs, among other examples. The example 500 may correspond to procedures associated with an LTM preparation phase or a pre-synchronization phase, as described with respect to FIG. 2.

As shown by reference number 520, the UE 120 may be configured with one or more LTM candidate configurations, as described herein with respect to FIGS. 3 and 4. In some aspects, the one or more LTM candidate configurations may include or indicate one or more NES feature configurations associated with one or more NES features corresponding to one or more candidate DUs 515, as described herein. Additionally, or alternatively, the one or more LTM candidate configurations may configure the UE 120 to monitor for NES indications from the serving DU 505, the one or more candidate DUs 515, or a combination thereof, as described herein.

As shown by reference number 525, the UE 120 may transmit, to the serving CU 510, a measurement report (e.g., an L1 measurement report), as described herein. For example, the UE 120 may transmit the measurement report in accordance with one or more measurements associated with the one or more candidate DUs 515. In some aspects, the one or more measurements may be performed in accordance with the one or more LTM candidate configurations. For example, the UE 120 may measure one or more SSBs or CSI-RSs in accordance with the one or more NES feature configurations

As shown by reference number 530, the serving DU 505 or the one or more candidate DUs 515 may determine one or more NES indications associated with one or more LTM candidate cells (e.g., associated with the one or more candidate DUs 515). In some aspects, the determination of the one or more NES indications may be based on one or more measurement reports received from the UE 120 (e.g., transmitted by the UE 120 and forwarded by the serving CU 510), a network loading associated with the one or more LTM candidate cells, network energy saving techniques, or other conditions. In some examples, the one or more NES indications may be associated with an update to an NES feature configuration for the one or more LTM candidate cells, as described herein.

As shown by reference number 535, the one or more candidate DUs 515 may transmit an NES indication notification to the serving CU 510. For example, when the one or more candidate DUs 515 determine an NES indication associated with the one or more LTM candidate cells, the one or more candidate DUs 515 may transmit the NES indication notification to the serving CU 510. In some aspects, the NES indication notification may include one or more LTM candidate cell identifiers or cell indexes associated with the one or more LTM candidate cells. Additionally, or alternatively, the NES indication may indicate the one or more LTM candidate cells via a first bitmap, where each bit of the first bitmap corresponds to a set of LTM candidate cells. For example, a bit of the first bitmap having a first bit value (e.g., “1”) may indicate that the NES indication is associated with an LTM candidate cell corresponding to the bit, and a bit of the first bitmap having a second bit value (e.g., “0”) may indicate that no NES indication is associated with an LTM candidate cell corresponding to the bit.

In some aspects, the NES indication notification may indicate one or more NES features (e.g., using a code point of configured NES features) associated with the one or more LTM candidate cells, or a corresponding configuration associated with the one or more NES features (e.g., feature index or feature ID). Additionally, or alternatively, the NES indication may include a second bitmap, where each bit of the second bitmap corresponds to a respective NES feature, and where a first bit (e.g., “1”) corresponds to an activation of a first NES feature (e.g., DTX or DRX or DTX and DRX combined) and a second bit (e.g., “0”) corresponds to a deactivation of a second NES feature (e.g., NES conditional handover mode). In some aspects, one or more configurations corresponding to the activated NES features may follow the second bitmap, and the one or more configurations may be included in the NES indication notification in an order that corresponds to the order of the second bitmap (e.g., of the activated NES features in the second bitmap). In some aspects, the NES indication notification may include at least one of a DTX or DRX configuration index or identifier, conditional handover (e.g., associated with offloading an NES cell), an SSB adaptation configuration index or identifier, a PRACH adaptation configuration index or identifier, or another configuration associated with NES features, as described herein. Additionally, or alternatively, the NES indication notification may include a time reference (e.g., a timeline) associated with an activation or deactivation for the one or more NES features (e.g., a period during which each NES feature is active or inactive).

As shown by reference number 540, the serving CU 510 may transmit the NES indication notification to the serving DU 505. In some aspects, the NES indication notification may be the NES indication notification received from the one or more candidate DUs 515 or may be a different NES indication notification. For example, the serving CU 510 may transmit an NES indication notification including only information associated with LTM candidate cells corresponding to the UE 120 or UEs 120 served by the serving DU 505.

As shown by reference number 545, the serving DU 505 may transmit, and the UE 120 may receive, one or more NES indications. For example, the one or more NES indications may be associated with the NES indication notification received as described in connection with reference number 540. In some aspects, the one or more NES indications may be associated with an update to an NES feature configuration for the one or more LTM candidate cells, as described herein. For example, the one or more NES indications may include one or more NES parameters (e.g., active or inactive durations, on-durations or off-durations, beams, spatial filters, or other parameters) associated with the one or more NES feature configurations for the one or more LTM candidate cells. In some examples, the one or more NES indications may be transmitted in accordance with the time reference associated with the activation or deactivation for the one or more NES features. For example, NES indications may be transmitted to signal the activation or the deactivation of an NES feature for an LTM candidate cell. Additionally, or alternatively, the one or more NES indications may include an indication of the time reference.

Additionally, or alternatively, as shown by reference number 550, the one or more candidate DUs 515 may directly transmit the one or more NES indications to the UE 120. For example, by transmitting the one or more NES indications directly to the UE 120, overhead associated with transmission of NES indication notifications between the one or more candidate DUs 515, the serving CU 510, and the serving DU 505 may be reduced. In some examples, the one or more NES indications may be transmitted (e.g., by the serving DU 505 or the one or more candidate DUs 515) via a MAC-CE or DCI. Additionally, or alternatively, the one or more NES indications may be transmitted to the UE 120 or a group of UEs 120 performing LTM procedures associated with the one or more LTM candidate cells.

In some aspects, such as when the UE 120 receives the one or more NES indications directly from the one or more candidate DUs 515, the UE 120 may transmit an indication of information associated with the one or more NES indications to the serving DU 505 or the serving CU 510. For example, the UE 120 may be configured to transmit an NES indication report (e.g., via a MAC-CE) that may include one or more cell identifiers (e.g., cell indexes, for the one or more LTM candidate cells), one or more NES features or NES states, or NES feature configuration information to the serving DU 505 in accordance with the one or more NES indications received from the one or more candidate DUs 515. Additionally, or alternatively, the UE 120 may include an indication of the one or more NES features or NES states in measurement reports transmitted to the serving DU 505. In some aspects, the serving DU 505 may be configured to transmit an NES indication status message to the serving CU 510, and the NES indication status message may include at least one of the one or more cell identifiers, the one or more NES features or NES states, or the NES feature configuration information in accordance with the information received from the UE 120.

As shown by reference number 555, the serving DU 505 may determine one or more TCI states in accordance with the one or more NES features associated with the one or more LTM candidate cells. For example, the one or more TCI states may be determined in accordance with one or more NES feature configurations that may be active or inactive for the one or more LTM candidate cells. In some aspects, the serving DU 505 may activate a TCI state based on DTX or DRX on-durations (e.g., active durations) associated with a corresponding LTM candidate cell. Additionally, or alternatively, the serving DU 505 may determine to activate a TCI state based on beams, spatial filters, or CSI-RSs associated with on-demand SSB transmissions or SSB adaptation techniques enabled for a corresponding LTM candidate cell.

As shown by the reference number 560, the serving DU 505 may transmit an indication of the one or more TCI states to the UE 120. For example, the serving DU 505 may transmit a message that activates at least one TCI state for at least one LTM candidate cell based on determining to activate a TCI state in accordance with NES feature configurations for the at least one LTM candidate cell, as described herein.

As shown by the reference number 565, the UE 120 may conduct a pre-synchronization procedure with the one or more candidate DUs 515, as described herein with respect to FIG. 2. In some aspects, the pre-synchronization procedure may include a downlink pre-synchronization procedure. The UE 120 may perform the downlink pre-synchronization procedure in accordance with the one or more NES indications for the one or more LTM candidate cells. For example, the downlink pre-synchronization procedure may include an SSB transmission synchronization that may be based on at least one of a DTX active duration, an on-demand SSB transmission configuration, or an SSB adaptation period associated with the one or more LTM candidate cells. In some aspects, the UE 120 may use beams corresponding to the activated TCI states received from the serving DU 505.

Additionally, or alternatively, the pre-synchronization procedure may include an uplink pre-synchronization procedure. In some aspects, the uplink pre-synchronization procedure may be performed in accordance with the one or more NES indications for the one or more LTM candidate cells. For example, the UE 120 may derive a timing advance based on the one or more NES indications (e.g., based on at least one of a DTX or DRX on-duration, an on-demand SSB transmission, or an SSB adaptation period, as described in connection with the reference number 565).

Additionally, or alternatively, as shown by the reference number 570, the serving DU 505 may transmit, and the UE 120 may receive, an indication of a PDCCH order for the uplink pre-synchronization procedure, where the PDCCH order corresponds to a procedure or command transmitted by the serving DU 505 to initiate a RACH procedure for the UE 120. In some aspects, the PDCCH order may be based on the one or more NES indications. For example, the PDCCH order may be based on at least one of a DTX or DRX on-duration, RACH occasions associated with on-demand SSB or SSB adaptation techniques, or RACH occasions associated with PRACH adaptation techniques.

As shown by the reference number 575, the UE 120 may transmit a preamble message in accordance with the PDCCH order (e.g., as part of the uplink pre-synchronization procedure) to the one or more candidate DUs 515. The preamble message may be associated with obtaining a timing advance for an LTM candidate cell in accordance with the PDCCH order.

Accordingly, the UE 120 may receive an NES indication associated with NES features activated, deactivated, or configured for one or more LTM candidate cells, thereby supporting a pre-synchronization procedure between the UE 120 and the one or more LTM candidate cells even as NES features are implemented for the one or more LTM candidate cells.

As indicated above, FIG. 5 is provided as an example. Other examples may differ from what is described with respect to FIG. 5. For example, some steps shown in the example 500 may be omitted, performed in a different order than shown, or performed by different devices. Additionally, or alternatively, additional steps not shown may be performed.

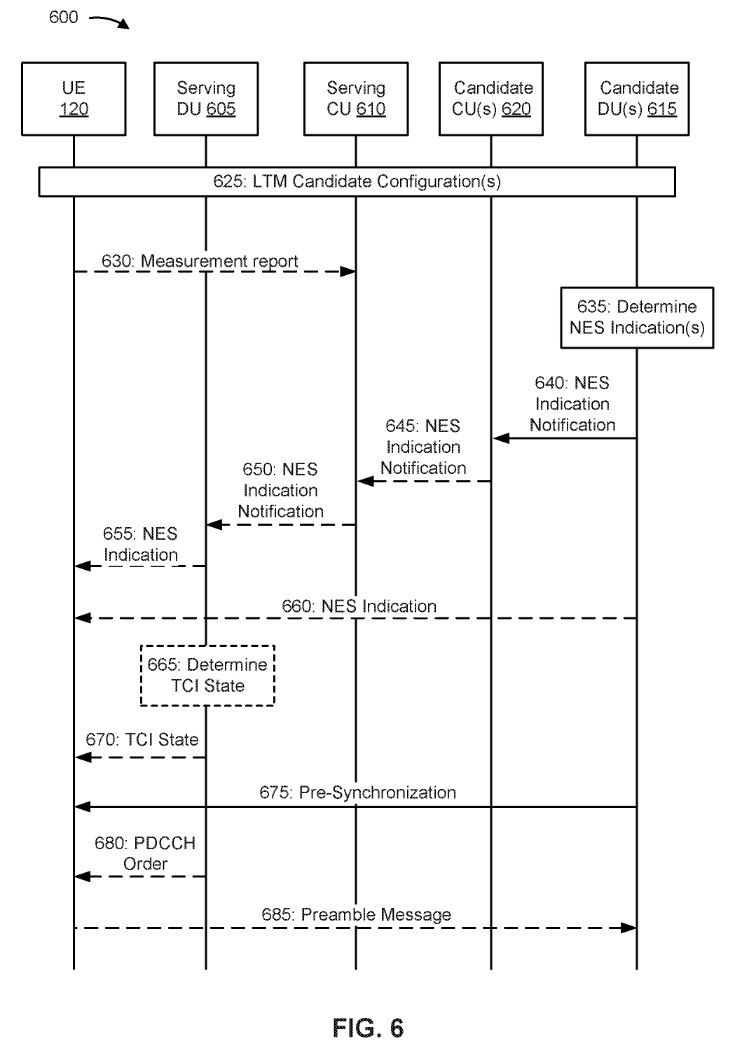

FIG. 6 is a diagram of an example 600 associated with synchronization procedures for inter-CU LTM. The example 600 illustrates communications between a UE 120, a serving DU 605 (or source DU), a serving CU 610 (or source CU) associated with the serving DU 605, and one or more candidate DUs 615 (or target DUs), and one or more candidate CUs 620 associated with the one or more candidate DUs 615. The serving DU 605, the serving CU 610, the one or more candidate DUs 615, and the one or more candidate CUs 620 may be examples of one or more network nodes 110, and operations attributed to the serving DU 605, the serving CU 610, the one or more candidate DUs 615, or the one or more candidate CUs 620 may instead be performed by one or more network nodes 110 such as one or more CUs, one or more DUs, one or more RUs, one or more core network nodes, one or more network servers, one or more application servers, or one or more AMFs, among other examples.

The example 600 may correspond to an example where the serving DU 605 is associated with communications with the serving CU 610, but the one or more candidate DUs 615 are associated with communications with one or more candidate CUs 620 that may be different from the serving CU 610. Accordingly, the example 600 may correspond to inter-CU LTM procedures. The example 600 may correspond to procedures associated with an LTM preparation phase and the pre-synchronization phase, as described with respect to FIGS. 2 and 5.

As shown by reference number 625, the UE 120 may be configured with one or more LTM candidate configurations, as described herein with respect to FIGS. 3-5. In some aspects, the one or more LTM candidate configurations may include or indicate one or more NES feature configurations associated with one or more NES features by the one or more candidate DUs 615, as described herein. Additionally, or alternatively, the one or more LTM candidate configurations may configure the UE 120 to monitor for NES indications from the one or more candidate DUs 615, as described herein.

As shown by reference number 630, the UE 120 may transmit, to the serving CU 610, a measurement report (e.g., an L1 measurement report), as described herein. For example, the UE 120 may transmit the measurement report in accordance with one or more measurements associated with the one or more candidate DUs 615. In some aspects, the one or more measurements may be performed in accordance with the one or more LTM candidate configurations. For example, the UE 120 may measure one or more SSBs or CSI-RSs in accordance with the one or more NES feature configurations

As shown by reference number 635, the one or more candidate DUs 615 may determine one or more NES indications associated with one or more LTM candidate cells (e.g., associated with the one or more candidate DUs 615). In some aspects, the determination of the one or more NES indications may be based on one or more measurement reports received from the UE 120, a network loading associated with the one or more LTM candidate cells, network energy saving techniques, or other conditions. In some examples, the one or more NES indications may be associated with an update to an NES feature configuration for the one or more LTM candidate cells, as described herein.

As shown by reference number 640, the one or more candidate DUs 615 may transmit an NES indication notification to the one or more candidate CUs 620. In some aspects, the NES indication notification may include one or more LTM candidate cell identifiers or cell indexes associated with the one or more LTM candidate cells. Additionally, or alternatively, the NES indication may indicate the one or more LTM candidate cells via a first bitmap, as described herein with respect to FIG. 5.

In some aspects, the NES indication notification may indicate one or more NES features (e.g., using a code point of configured NES features) associated with the one or more LTM candidate cells, or a corresponding configuration associated with the one or more NES features. Additionally, or alternatively, the NES indication may include a second bitmap indicating activated or deactivated NES features, as described herein with respect to FIG. 5. In some aspects, the NES indication notification may include at least one of a DTX or DRX configuration index or identifier, an SSB adaptation configuration index or identifier, a PRACH adaptation configuration index or identifier, or another configuration associated with NES features, as described herein. Additionally, or alternatively, the NES indication notification may include a time reference (e.g., a timeline) associated with an activation or deactivation for the one or more NES features (e.g., a period during which each NES feature is active or inactive).

As shown by reference number 645, the one or more candidate CUs 620 may transmit the NES indication notification to the serving CU 610. In some aspects, the NES indication notification may be the NES indication notification received from the one or more candidate DUs 615 or may be a different NES indication notification. For example, the one or more candidate CUs 620 may transmit an NES indication notification including only information associated with LTM candidate cells corresponding to the UE 120 or UEs 120 served by the serving CU 610.

As shown by reference number 650, the serving CU 610 may transmit the NES indication notification to the serving DU 605. In some aspects, the NES indication notification may be the NES indication notification received from the one or more candidate CUs 620 or may be a different NES indication notification. For example, the serving CU 610 may transmit an NES indication notification including only information associated with LTM candidate cells corresponding to the UE 120 or UEs 120 served by the serving DU 605.

As shown by reference number 655, the serving DU 605 may transmit, and the UE 120 may receive, one or more NES indications. For example, the one or more NES indications may be associated with the NES indication notification. In some aspects, the one or more NES indications may be associated with an update to an NES feature configuration for the one or more LTM candidate cells, as described herein. In some examples, the NES indication may be transmitted in accordance with the time reference associated with the activation or deactivation for the one or more NES features. For example, NES indications may be transmitted to signal the activation or the deactivation of an NES feature for an LTM candidate cell. Additionally, or alternatively, the one or more NES indications may include an indication of the time reference.

Additionally, or alternatively, as shown by reference number 660, the one or more candidate DUs 615 may directly transmit the one or more NES indications to the UE 120. For example, by transmitting the one or more NES indications directly to the UE 120, overhead associated with transmission of NES indication notifications between the one or more candidate DUs 615, the one or more candidate CUs 620, the serving CU 610, and the serving DU 605 may be reduced. In some examples, the one or more NES indications may be transmitted (e.g., by the serving DU 505 or the one or more candidate DUs 515) via a MAC-CE or DCI. Additionally, or alternatively, the one or more NES indications may be transmitted to the UE 120 or a group of UEs 120 performing LTM procedures associated with the one or more LTM candidate cells. In some aspects, such as when the UE 120 receives the one or more NES indications directly from the one or more candidate DUs 615, the UE 120 may transmit an indication of information associated with the one or more NES indications to the serving DU 605 or the serving CU 610, as described herein.

As shown by reference number 665, the serving DU 605 may determine one or more TCI states in accordance with the one or more NES features associated with the one or more LTM candidate cells, as described herein with respect to FIG. 5. For example, the one or more TCI states may be determined in accordance with one or more NES feature configurations that may be active or inactive for the one or more LTM candidate cells, or one or more parameters (e.g., on-durations, beams, spatial filters, or other parameters) associated with the one or more NES feature configurations.

As shown by the reference number 670, the serving DU 605 may transmit an indication of the one or more TCI states to the UE 120. For example, the serving DU 605 may transmit a message that activates at least one TCI state for at least one LTM candidate cell based on determining to activate a TCI state in accordance with NES feature configurations for the at least one LTM candidate cell, as described herein with respect to FIG. 5.

As shown by the reference number 675, the UE 120 may conduct a pre-synchronization procedure with the one or more candidate DUs 615, as described herein with respect to FIGS. 2 and 5. In some aspects, the pre-synchronization procedure may include a downlink pre-synchronization procedure, and the UE 120 may perform the downlink pre-synchronization procedure in accordance with the one or more NES indications for the one or more LTM candidate cells, as described herein with respect to FIG. 5. In some aspects, the UE 120 may use beams corresponding to the activated TCI states received from the serving DU 605.

Additionally, or alternatively, the pre-synchronization procedure may include an uplink pre-synchronization procedure. In some aspects, the uplink pre-synchronization procedure may be performed in accordance with the one or more NES indications for the one or more LTM candidate cells, as described herein with reference to FIG. 5. For example, the UE 120 may derive a timing advance based on the one or more NES indications (e.g., based on at least one of a DTX or DRX on-duration, an on-demand SSB transmission, or an SSB adaptation period as described in the connection with the reference number 675).

Additionally, or alternatively, as shown by the reference number 680, the serving DU 605 may transmit, and the UE 120 may receive, an indication of a PDCCH order for the uplink pre-synchronization procedure. In some aspects, the PDCCH order may be based on the one or more NES indications, as described herein with respect to FIG. 5.

As shown by the reference number 685, the UE 120 may transmit a preamble message in accordance with the PDCCH order (e.g., as part of the uplink pre-synchronization procedure) to the one or more candidate DUs 615. The preamble message may be associated with obtaining a timing advance for an LTM candidate cell in accordance with the PDCCH order.

Accordingly, the UE 120 may receive an NES indication associated with NES features activated, deactivated, or configured for one or more LTM candidate cells, even when the one or more LTM candidate cells are associated with a different CU than the serving CU 610.

As indicated above, FIG. 6 is provided as an example. Other examples may differ from what is described with respect to FIG. 6. For example, some steps shown in the example 600 may be omitted, performed in a different order than shown, or performed by different devices. Additionally, or alternatively, additional steps not shown may be performed.

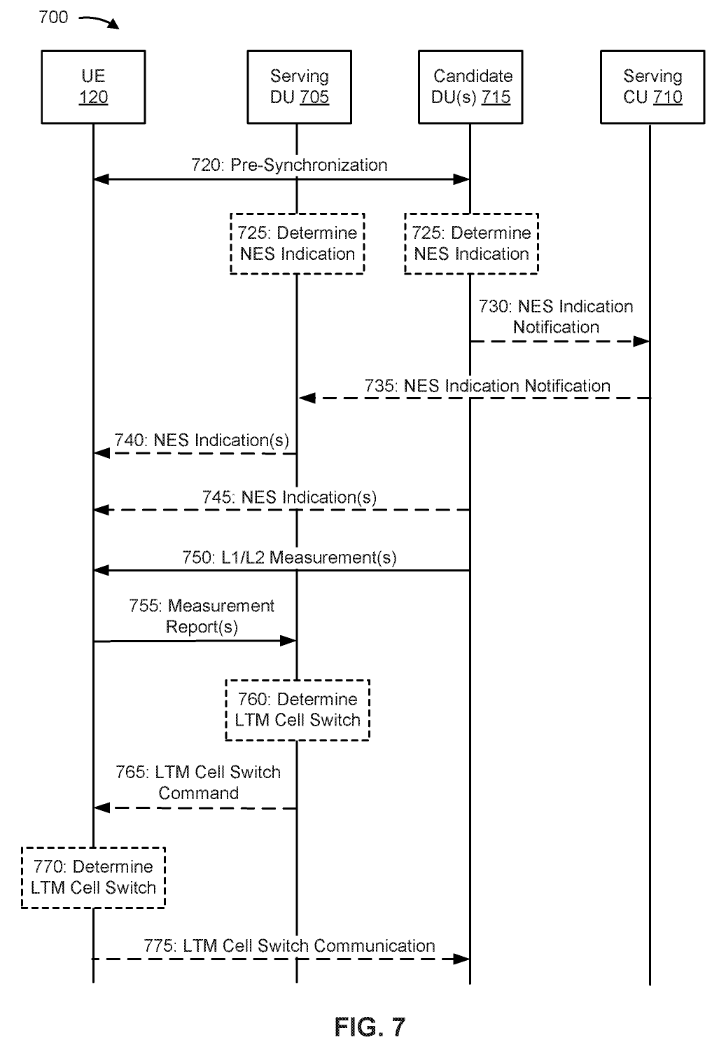

FIG. 7 is a diagram of an example 700 associated with LTM cell switching for intra-CU LTM. The example 700 illustrates communications between a UE 120, a serving DU 705 (or source DU), a serving CU 710 (or source CU) associated with the serving DU 705, and one or more candidate DUs 715 (or target DUs) associated with the serving CU 710. The serving DU 705, the serving CU 710, and the one or more candidate DUs 715 may be examples of one or more network nodes 110, and operations attributed to the serving DU 705, the serving CU 710, or the one or more candidate DUs 715 may instead be performed by one or more network nodes 110 such as one or more CUs, one or more DUs, one or more RUs, one or more core network nodes, one or more network servers, one or more application servers, or one or more AMFs, among other examples. The example 700 may correspond to a pre-synchronization phase and an LTM execution phase of an LTM procedure, as described herein with respect to FIG. 2.

As shown by reference number 720, the UE 120 may perform a pre-synchronization procedure for one or more LTM candidate cells associated with the one or more candidate DUs 715. For example, the UE 120 may perform a downlink pre-synchronization procedure and an uplink pre-synchronization procedure, as described herein with respect to FIGS. 5 and 6.

As shown by reference number 725, the serving DU 705 or the one or more candidate DUs 715 may determine one or more NES indications associated with one or more LTM candidate cells (e.g., associated with the one or more candidate DUs 715), as described herein with respect to FIG. 5. In some aspects, the determination of the one or more NES indications may be based on one or more measurement reports received from the UE 120, a network loading associated with the one or more LTM candidate cells, network energy saving techniques, or other conditions. In some examples, the one or more NES indications may be associated with an update to an NES feature configuration for the one or more LTM candidate cells, as described herein.

As shown by reference number 730, the one or more candidate DUs 715 may transmit an NES indication notification to the serving CU 710, as described with respect to FIG. 5. For example, when the one or more candidate DUs 715 determine an NES indication associated with the one or more LTM candidate cells, the one or more candidate DUs 715 may transmit the NES indication notification to the serving CU 710. In some aspects, the NES indication notification may indicate at least one NES feature activated for the one or more LTM candidate cells, or a corresponding configuration associated with the one or more NES features, as described herein. Additionally, or alternatively, the NES indication notification may include a time reference (e.g., a timeline) associated with an activation or deactivation for the one or more NES features (e.g., a period during which each NES feature is active or inactive).

As shown by reference number 735, the serving CU 710 may transmit the NES indication notification to the serving DU 705. In some aspects, the NES indication notification may be the NES indication notification received from the one or more candidate DUs 715 or may be a different NES indication notification. For example, the serving CU 710 may transmit an NES indication notification including only information associated with LTM candidate cells corresponding to the UE 120 or UEs 120 served by the serving DU 705.

As shown by reference number 740, the serving DU 705 may transmit, and the UE 120 may receive, one or more NES indications, as described herein with reference to FIGS. 5 and 6. For example, the one or more NES indications may be associated with the NES indication notification. In some aspects, the one or more NES indications may include one or more NES parameters (e.g., active or inactive durations, on-durations or off-durations, beams, spatial filters, or other parameters) associated with the one or more NES feature configurations for the one or more LTM candidate cells.

Additionally, or alternatively, as shown by reference number 745, the one or more candidate DUs 715 may directly transmit the one or more NES indications to the UE 120, as described with reference to FIGS. 5 and 6. For example, by transmitting the one or more NES indications directly to the UE 120, overhead associated with transmission of NES indication notifications between the one or more candidate DUs 715, the serving CU 710, and the serving DU 705 may be reduced.

As shown by reference number 750, the UE 120 may perform one or more L1/L2 measurements associated with the one or more candidate DUs 715 in accordance with the one or more NES indications. For example, the UE 120 may perform the one or more L1/L2 measurements of one or more SSBs or one or more CSI-RSs, which may be performed in accordance with one or more NES parameters associated with on-demand SSB or SSB adaptation techniques, or DTX on-durations (e.g., active durations). Additionally, or alternatively, the one or more L1/L2 measurements may be triggered by an on-demand SSB transmission or transmission of an SSB in accordance with SSB adaptation techniques. Additionally, or alternatively, a filtering for the L1/L2 measurements may be based on one or more DTX on-durations over one or more DTX cycles.

As shown by reference number 755, the UE 120 may transmit (e.g., to the serving DU 705) one or more measurement reports (e.g., L1/L2 measurement reports) in accordance with the one or more L1/L2 measurements. In some aspects, the one or more measurement reports may be in accordance with the one or more NES indications. For example, the one or more measurement reports may be transmitted in accordance with a DRX on-duration (e.g., active duration) that may be associated with the serving DU 705. Additionally, or alternatively, the one or more measurement reports may be triggered by an on-demand SSB transmission or transmission of an SSB in accordance with SSB adaptation techniques of the serving DU 705.

As shown by reference number 760, the serving DU 705 may determine for an LTM cell switch to be initiated for the UE 120. For example, the serving DU 705 may determine for the LTM cell switch to be initiated in accordance with the one or more NES indications, the one or more measurement reports, or a combination thereof. In some aspects, a target cell for the LTM cell switch may be selected in accordance with a DTX or DRX active duration and active cycle. For example, a cell of the one or more LTM candidate cells having an earliest active duration or a longest active duration may be selected as the target cell. Additionally, or alternatively, when an NES indication includes an NES conditional handover indication associated with offloading an LTM candidate cell of the one or more LTM candidate cells, the LTM candidate cell may be excluded (e.g., not selected as the target cell), which may allow for the offloading of the cell in accordance with NES techniques.

In some aspects, the serving DU 705 may select a target cell in accordance with configured grant resources associated with a DTX or DRX active duration and active cycle for the one or more LTM candidate cells (e.g., a cell having more configured grant resources may be prioritized over a cell having less configured grant resources). Additionally, or alternatively, the serving DU 705 may select a target cell in accordance with PRACH resources associated with the DTX or DRX active duration and active cycle, on-demand SSB transmissions, SSB adaptation configurations, or PRACH adaptation configurations for the one or more LTM candidate cells (e.g., a cell having more available PRACH resources may be prioritized over a cell having less available PRACH resources). Additionally, or alternatively, the target cell may be selected in accordance with the one or more L1/L2 measurements reported by the UE 120, which may be in accordance with the NES configurations such as on-demand SSB configurations or SSB adaptation configurations of the one or more LTM candidate cells. Additionally, or alternatively, the UE 120 may include an NES indication in a measurement report of the one or more measurement reports.

As shown by reference number 765, the serving DU 705 may transmit, and the UE 120 may receive, an LTM cell switch command. The LTM cell switch command may indicate the UE 120 to perform a cell switch to the target cell. In some aspects, the LTM cell switch command may include NES information associated with performing the cell switch or communicating with the target cell. For example, NES information may include a timeline for performing the LTM cell switch. In some aspects, the timeline may be associated with performing the LTM cell switch using configured grant resources in accordance with DTX or DRX active durations and active cycles associated with the target cell. Additionally, or alternatively, the timeline may be associated with performing the LTM cell switch using PRACH resources in accordance with DTX or DRX active durations and active cycles, an on-demand SSB configuration, an SSB adaptation configuration, or a PRACH adaptation configuration associated with the target cell. Additionally, or alternatively, the NES information may include a beam for communications with the target cell in accordance with the on-demand SSB configuration or the SSB adaptation configuration. In some aspects, the NES information may include a timeline for an LTM recovery procedure in accordance with DTX or DRX active durations and active cycles, an on-demand SSB configuration, an SSB adaptation configuration, or a PRACH adaptation configuration associated with the target cell.

As shown by reference number 770, the UE 120 may autonomously determine to perform an LTM cell switch. For example, the UE 120 may be configured with one or more conditions for performing a conditional LTM cell switch (e.g., via the one or more LTM candidate configurations). For instance, the UE 120 may exclude an LTM candidate cell from consideration when the one or more NES indications include a NES conditional handover indication associated with offloading the LTM candidate cell to reduce network congestion. Additionally, the UE 120 may select an LTM candidate cell for switching based on a DTX or DRX active duration and active cycle associated with the one or more LTM candidate cells. For example, the UE 120 may prioritize a candidate cell with the earliest active duration or the longest active duration, which may prioritize sustained connectivity.

Additionally, or alternatively, the UE 120 may determine to perform an LTM cell switch in accordance with one or more switching conditions or event triggers adapted with on-demand SSB transmissions or SSB adaptation techniques, for example, in accordance with a satisfaction of one or more L1/L2 measurement thresholds during one or more evaluation windows associated with the on-demand SSB transmissions or SSB adaptation techniques. Additionally, or alternatively, the UE 120 may factor in configured grant resources and PRACH resources associated with DTX or DRX active durations and active cycles, on-demand SSB, SSB adaptation, or PRACH adaptation techniques, which may ensure that the selected LTM candidate cell may support communications during the LTM cell switch.

As shown by the reference number 775, the UE 120 may perform an LTM cell switch communication associated with the LTM cell switch. In some aspects, the UE 120 may conduct a RACH-less communication to perform (or initiate) the LTM cell switch (e.g., using configured grant resources). Additionally, or alternatively, the UE 120 may perform a RACH-based communication to perform (or initiate) the LTM cell switch, initiating a random access procedure to establish synchronization and communication with the target cell. The LTM cell switch communication may be transmitted to at least one candidate DU 715 associated with the target cell in accordance with receiving the LTM cell switch command or determining to perform an autonomous (e.g., conditional) LTM cell switch, as described herein.

Accordingly, by supporting transmissions of NES indications, a wireless communication system may support performing LTM cell switches while supporting NES techniques for LTM candidate cells or the serving DU 705, thereby enhancing network efficiency and maintaining robust connectivity in accordance with LTM procedures.

As indicated above, FIG. 7 is provided as an example. Other examples may differ from what is described with respect to FIG. 7. For example, some steps shown in the example 700 may be omitted, performed in a different order than shown, or performed by different devices. Additionally, or alternatively, additional steps not shown may be performed.

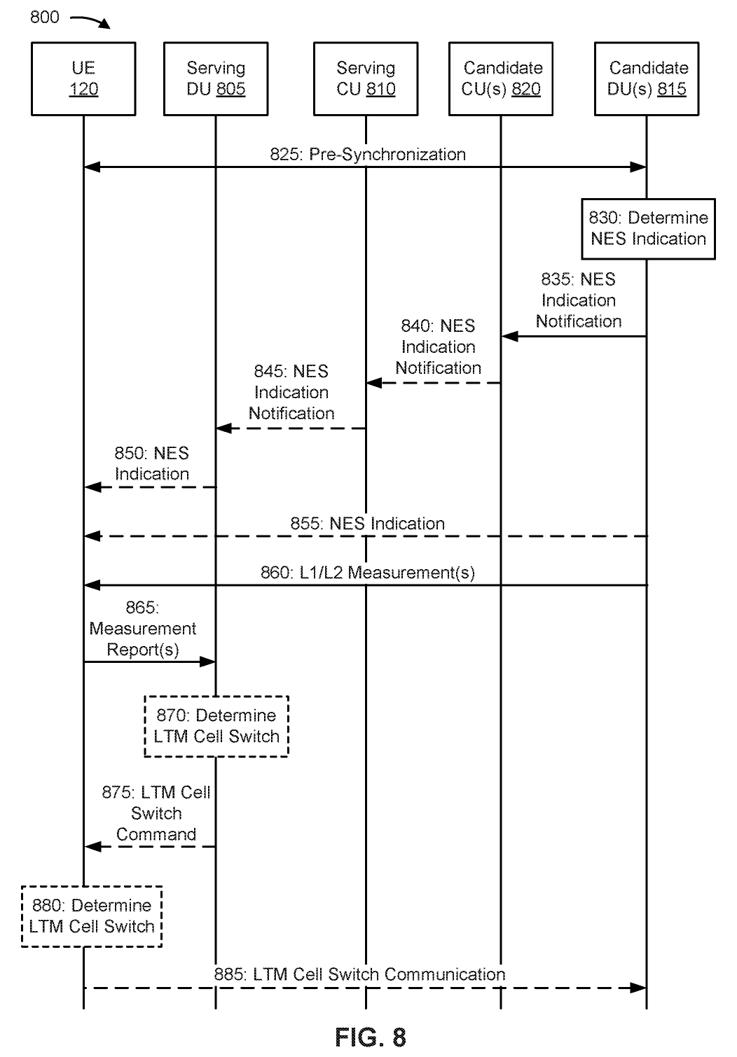

FIG. 8 is a diagram of an example 800 associated with LTM cell switching for inter-CU LTM. The example 800 illustrates communications between a UE 120, a serving DU 805 (or source DU), a serving CU 810 (or source CU) associated with the serving DU 805, and one or more candidate DUs 815 (or target DUs), and one or more candidate CUs 820 associated with the one or more candidate DUs 815. The serving DU 805, the serving CU 810, the one or more candidate DUs 815, and the one or more candidate CUs 820 may be examples of one or more network nodes 110, and operations attributed to the serving DU 805, the serving CU 810, the one or more candidate DUs 815, or the one or more candidate CUs 820 may instead be performed by one or more network nodes 110 such as one or more CUs, one or more DUs, one or more RUs, one or more core network nodes, one or more network servers, one or more application servers, or one or more AMFs, among other examples.

The example 800 may correspond to an example where the serving DU 805 is associated with communications with the serving CU 810, but the one or more candidate DUs 815 are associated with communications with one or more candidate CUs 820 that may be different from the serving CU 810. Accordingly, the example 800 may correspond to inter-CU LTM procedures. The example 800 may correspond to procedures associated with a pre-synchronization phase and an LTM execution phase of an LTM procedure, as described with respect to FIGS. 2 and 7.

As shown by reference number 825, the UE 120 may perform a pre-synchronization procedure for one or more LTM candidate cells associated with the one or more candidate DUs 815. For example, the UE 120 may perform a downlink pre-synchronization procedure and an uplink pre-synchronization procedure, as described herein with respect to FIGS. 5 and 6.

As shown by reference number 830, the one or more candidate DUs 815 may determine one or more NES indications associated with one or more LTM candidate cells (e.g., associated with the one or more candidate DUs 815). In some aspects, the determination of the one or more NES indications may be based on one or more measurement reports received from the UE 120, a network loading associated with the one or more LTM candidate cells, network energy saving techniques, or other conditions. In some examples, the one or more NES indications may be associated with an update to an NES feature configuration for the one or more LTM candidate cells, as described herein.

As shown by reference number 835, the one or more candidate DUs 815 may transmit an NES indication notification to the one or more candidate CUs 820. In some aspects, the NES indication notification may include one or more LTM candidate cell identifiers or cell indexes associated with the one or more LTM candidate cells. Additionally, or alternatively, the NES indication may indicate the one or more LTM candidate cells via a first bitmap, as described herein with respect to FIG. 5. In some aspects, the NES indication notification may indicate one or more NES features (e.g., using a code point of configured NES features) associated with the one or more LTM candidate cells, or a corresponding configuration associated with the one or more NES features, as described herein with respect to FIGS. 5-7.

As shown by reference number 840, the one or more candidate CUs 820 may transmit the NES indication notification to the serving CU 810. In some aspects, the NES indication notification may be the NES indication notification received from the one or more candidate DUs 815 or may be a different NES indication notification. For example, the one or more candidate CUs 820 may transmit an NES indication notification including only information associated with LTM candidate cells corresponding to the UE 120 or UEs 120 served by the serving CU 810.

As shown by reference number 845, the serving CU 810 may transmit the NES indication notification to the serving DU 805. In some aspects, the NES indication notification may be the NES indication notification received from the one or more candidate CUs 820 or may be a different NES indication notification. For example, the serving CU 810 may transmit an NES indication notification including only information associated with LTM candidate cells corresponding to the UE 120 or UEs 120 served by the serving DU 805.

As shown by reference number 850, the serving DU 805 may transmit, and the UE 120 may receive, one or more NES indications. For example, the one or more NES indications may be associated with the NES indication notification. In some aspects, the one or more NES indications may be associated with an update to an NES feature configuration for the one or more LTM candidate cells, as described herein. In some examples, the NES indication may be transmitted in accordance with the time reference associated with the activation or deactivation for the one or more NES features. For example, NES indications may be transmitted to signal the activation or the deactivation of an NES feature for an LTM candidate cell. Additionally, or alternatively, the one or more NES indications may include an indication of the time reference.

Additionally, or alternatively, as shown by reference number 855, the one or more candidate DUs 815 may directly transmit the one or more NES indications to the UE 120. For example, by transmitting the one or more NES indications directly to the UE 120, overhead associated with transmission of NES indication notifications between the one or more candidate DUs 815, the one or more candidate CUs 820, the serving CU 810, and the serving DU 805 may be reduced. In some examples, the one or more NES indications may be transmitted (e.g., by the serving DU 805 or the one or more candidate DUs 815) via a MAC-CE or DCI. Additionally, or alternatively, the one or more NES indications may be transmitted to the UE 120 or a group of UEs 120 performing LTM procedures associated with the one or more LTM candidate cells.

As shown by reference number 860, the UE 120 may perform one or more L1/L2 measurements associated with the one or more candidate DUs 815 in accordance with the one or more NES indications, as described herein with respect to FIG. 7. For example, the UE 120 may perform the one or more L1/L2 measurements in accordance with one or more NES parameters associated with on-demand SSB or SSB adaptation techniques, or DTX on-durations (e.g., active durations). Additionally, or alternatively, the one or more L1/L2 measurements may be triggered by an on-demand SSB transmission or transmission of an SSB in accordance with SSB adaptation techniques, or a filtering for the L1/L2 measurements may be based on one or more DTX on-durations over one or more DTX cycles.

As shown by reference number 865, the UE 120 may transmit (e.g., to the serving DU 805) one or more measurement reports (e.g., L1/L2 measurement reports) in accordance with the one or more L1/L2 measurements, as described herein with respect to FIG. 7. In some aspects, the one or more measurement reports may be in accordance with the one or more NES indications. Additionally, or alternatively, the one or more measurement reports may be triggered by an on-demand SSB transmission or transmission of an SSB in accordance with SSB adaptation techniques of the serving DU 805.

As shown by reference number 870, the serving DU 805 may determine for an LTM cell switch to be initiated for the UE 120, as described herein with respect to FIG. 7. For example, the serving DU 805 may determine for the LTM cell switch to be initiated in accordance with the one or more NES indications, the one or more measurement reports, or a combination thereof. In some aspects, a target cell for the LTM cell switch may be selected in accordance with the one or more NES indications, as described herein.

As shown by reference number 875, the serving DU 805 may transmit, and the UE 120 may receive, an LTM cell switch command. The LTM cell switch command may indicate the UE 120 to perform a cell switch to the target cell. In some aspects, the LTM cell switch command may include NES information associated with performing the cell switch or communicating with the target cell, as described herein with respect to FIG. 7. For example, NES information may include a timeline for performing the LTM cell switch. Additionally, or alternatively, the NES information may include a beam for communications with the target cell in accordance with the on-demand SSB configuration or the SSB adaptation configuration. In some aspects, the NES information may include a timeline for an LTM recovery procedure in accordance with DTX or DRX active durations and active cycles, an on-demand SSB configuration, an SSB adaptation configuration, or a PRACH adaptation configuration associated with the target cell.

As shown by reference number 880, the UE 120 may autonomously determine to perform an LTM cell switch, as described herein with respect to FIG. 7. For example, the UE 120 may be configured with one or more conditions for performing a conditional LTM cell switch (e.g., via the one or more LTM candidate configurations). For instance, the UE 120 may exclude an LTM candidate cell from consideration when the one or more NES indications include a NES conditional handover indication associated with offloading the LTM candidate cell to reduce network congestion. Additionally, or alternatively, the UE 120 may select an LTM candidate cell for switching based on a DTX or DRX active duration and active cycle associated with the one or more LTM candidate cells. Additionally, or alternatively, the UE 120 may determine to perform an LTM cell switch in accordance with one or more switching conditions or event triggers adapted with on-demand SSB transmissions or SSB adaptation techniques, as described herein with respect to FIG. 7.

As shown by the reference number 885, the UE 120 may perform an LTM cell switch communication associated with the LTM cell switch. In some aspects, the UE 120 may conduct a RACH-less communication to perform (or initiate) the LTM cell switch (e.g., using configured grant resources). Additionally, or alternatively, the UE 120 may perform a RACH-based communication to perform (or initiate) the LTM cell switch, initiating a random access procedure to establish synchronization and communication with the target cell. The LTM cell switch communication may be transmitted to at least one candidate DU 815 associated with the target cell in accordance with receiving the LTM cell switch command or determining to perform an autonomous (e.g., conditional) LTM cell switch, as described herein.

Accordingly, by supporting transmissions of NES indications, a wireless communication system may support performing LTM cell switches while supporting NES techniques for LTM candidate cells or the serving DU 805, thereby enhancing network efficiency and maintains robust connectivity in accordance with LTM procedures even in cases where the LTM candidate cells and a serving cell correspond to different CUs.

As indicated above, FIG. 8 is provided as an example. Other examples may differ from what is described with respect to FIG. 8. For example, some steps shown in the example 800 may be omitted, performed in a different order than shown, or performed by different devices. Additionally, or alternatively, additional steps not shown may be performed.

FIG. 9 is a diagram illustrating an example process 900 performed, for example, at a UE or an apparatus of a UE. Example process 900 is an example where the apparatus or the UE (e.g., UE 120) performs operations associated with NES techniques for LTM procedures.

As shown in FIG. 9, in some aspects, process 900 may include receiving an NES indication that indicates one or more NES parameters associated with one or more candidate network nodes for LTM (block 910). For example, the UE (e.g., using reception component 1102 or communication manager 1106, depicted in FIG. 11) may receive an NES indication that indicates one or more NES parameters associated with one or more candidate network nodes for LTM, as described above.

As further shown in FIG. 9, in some aspects, process 900 may include communicating one or more messages with the one or more candidate network nodes in accordance with the one or more NES parameters as part of a synchronization procedure for LTM (block 920). For example, the UE (e.g., using reception component 1102, transmission component 1104, or communication manager 1106, depicted in FIG. 11) may communicate one or more messages with the one or more candidate network nodes in accordance with the one or more NES parameters as part of a synchronization procedure for LTM, as described above.

As further shown in FIG. 9, in some aspects, process 900 may include transmitting, to a serving network node, a measurement report in accordance with one or more measurements associated with the one or more candidate network nodes, wherein the one or more measurements are performed in accordance with the synchronization procedure and the one or more NES parameters (block 930). For example, the UE (e.g., using transmission component 1104 or communication manager 1106, depicted in FIG. 11) may transmit, to a serving network node, a measurement report in accordance with one or more measurements associated with the one or more candidate network nodes, wherein the one or more measurements are performed in accordance with the synchronization procedure and the one or more NES parameters, as described above.

Process 900 may include additional aspects, such as any single aspect or any combination of aspects described below or in connection with one or more other processes described elsewhere herein.

In a first aspect, process 900 includes receiving, from the serving network node, one or more LTM candidate configurations associated with one or more NES feature configurations for the one or more candidate network nodes.

In a second aspect, alone or in combination with the first aspect, the one or more NES feature configurations include at least one of a DTX configuration, a DRX configuration, an NES conditional handover configuration, an on-demand SSB configuration, an SSB adaptation configuration, or a PRACH adaptation configuration.

In a third aspect, alone or in combination with one or more of the first and second aspects, process 900 includes receiving, from the serving network node, a reconfiguration message that reconfigures at least one LTM candidate configuration of the one or more LTM candidate configurations in accordance with one or more updates associated with the one or more NES feature configurations or an additional NES indication associated with the one or more candidate network nodes.

In a fourth aspect, alone or in combination with one or more of the first through third aspects, the NES indication includes at least one of a DTX activation or deactivation, a DRX activation or deactivation, a NES conditional handover, an on-demand SSB transmission indication or termination, an SSB adaptation indication, or a PRACH adaptation indication.

In a fifth aspect, alone or in combination with one or more of the first through fourth aspects, the NES indication is received via a common search space associated in accordance with an identifier associated with the NES indication.

In a sixth aspect, alone or in combination with one or more of the first through fifth aspects, process 900 includes receiving, from the serving network node, an LTM cell switch command associated with a cell switch from the serving network node to a candidate network node of the one or more candidate network nodes, wherein the LTM cell switch command indicates at least one NES parameter associated with the candidate network node.

In a seventh aspect, alone or in combination with one or more of the first through sixth aspects, the at least one NES parameter associated with the candidate network node includes at least one of a timeline for the cell switch in accordance with an active duration for a DTX or DRX associated with the candidate network node, a timeline for the cell switch in accordance with an on-demand SSB configuration or indication, an SSB adaptation configuration or indication, a PRACH adaptation configuration or indication, a beam associated with the cell switch in accordance with the on-demand SSB configuration or indication or the SSB adaptation configuration or indication, or a timeline for an LTM recovery procedure in accordance with the active duration for the DTX or DRX.

In an eighth aspect, alone or in combination with one or more of the first through seventh aspects, process 900 includes performing an autonomous cell switch from the serving network node to a candidate network node of the one or more candidate network nodes in accordance with one or more conditions being satisfied, wherein the one or more conditions are satisfied in accordance with the NES indication or the one or more NES parameters.

In a ninth aspect, alone or in combination with one or more of the first through eighth aspects, the one or more conditions being satisfied include at least one of reception of an NES conditional handover indication associated with network node offloading, selection of a candidate network node in accordance with a switching execution timeline associated an active duration for DTX or DRX associated with the candidate network node, or satisfaction of one or more measurement thresholds in accordance with an on-demand SSB configuration or indication, an SSB adaptation configuration or indication, or one or more resources associated with a PRACH adaptation configuration or indication.

In a tenth aspect, alone or in combination with one or more of the first through ninth aspects, the NES indication includes at least one of an identifier associated with the one or more candidate network nodes or a bitmap indicating the one or more candidate network nodes.

In an eleventh aspect, alone or in combination with one or more of the first through tenth aspects, the NES indication includes an indication of one or more NES features activated for the one or more candidate network nodes and a respective NES feature configuration for each activated NES feature of the one or more NES features.

In a twelfth aspect, alone or in combination with one or more of the first through eleventh aspects, the NES indication includes a bitmap indicating the one or more NES features activated for the one or more candidate network nodes and one or more additional NES features deactivated for the one or more candidate network nodes, wherein an order of the respective NES feature configurations is in accordance with an order of the bitmap.

In a thirteenth aspect, alone or in combination with one or more of the first through twelfth aspects, the respective NES feature configurations include at least one of a DTX configuration, a DRX configuration, an on-demand SSB configuration, an SSB adaptation configuration, or a PRACH adaptation configuration.

In a fourteenth aspect, alone or in combination with one or more of the first through thirteenth aspects, the synchronization procedure includes a downlink synchronization in accordance with the NES indication, wherein the NES indication indicates at least one of an active duration associated with a DTX configuration for a candidate network node of the one or more candidate network nodes, an on-demand SSB transmission, or an SSB adaptation period.

In a fifteenth aspect, alone or in combination with one or more of the first through fourteenth aspects, process 900 includes receiving an indication of one or more TCI states activated in accordance with the NES indication, wherein the downlink synchronization is in accordance with the one or more TCI states.

In a sixteenth aspect, alone or in combination with one or more of the first through fifteenth aspects, the synchronization procedure includes an uplink synchronization in accordance with a timing advance that is based on the NES indication, wherein the NES indication indicates at least one of an active duration associated with a DTX or DRX configuration for the one or more candidate network nodes, an on-demand SSB transmission, or an SSB adaptation period.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a first network node or an apparatus of a first network node. Example process 1000 is an example where the apparatus or the first network node (e.g., a network node 110, a serving network node, or a candidate network node) performs operations associated with NES techniques for LTM procedures.

As shown in FIG. 10, in some aspects, process 1000 may include transmitting, to a UE, an NES indication that indicates one or more NES parameters associated with one or more candidate network nodes for LTM (block 1010). For example, the first network node (e.g., using transmission component 1204 or communication manager 1206, depicted in FIG. 12) may transmit, to a UE, an NES indication that indicates one or more NES parameters associated with one or more candidate network nodes for LTM, as described above.

As further shown in FIG. 10, in some aspects, process 1000 may include receiving, from the UE, a measurement report in accordance with one or more measurements associated with the one or more candidate network nodes, wherein the one or more measurements are performed in accordance with the one or more NES parameters (block 1020). For example, the first network node (e.g., using reception component 1202 or communication manager 1206, depicted in FIG. 12) may receive, from the UE, a measurement report in accordance with one or more measurements associated with the one or more candidate network nodes, wherein the one or more measurements are performed in accordance with the one or more NES parameters, as described above.

Process 1000 may include additional aspects, such as any single aspect or any combination of aspects described below or in connection with one or more other processes described elsewhere herein.

In a first aspect, process 1000 includes receiving, from a second network node, a message that includes the NES indication, wherein transmitting the NES indication to the UE is based at least in part on receiving the message.

In a second aspect, alone or in combination with the first aspect, process 1000 includes transmitting, to the UE, one or more LTM candidate configurations associated with one or more NES feature configurations for the one or more candidate network nodes.

In a third aspect, alone or in combination with one or more of the first and second aspects, the one or more NES feature configurations include at least one of a DTX configuration, a DRX configuration, an NES conditional handover configuration, an on-demand SSB configuration, an SSB adaptation configuration, or a PRACH adaptation configuration.

In a fourth aspect, alone or in combination with one or more of the first through third aspects, process 1000 includes transmitting, to the UE, a reconfiguration message that reconfigures at least one LTM candidate configuration of the one or more LTM candidate configurations in accordance with one or more updates associated with the one or more NES feature configurations or an additional NES indication associated with the one or more candidate network nodes.

In a fifth aspect, alone or in combination with one or more of the first through fourth aspects, the NES indication includes at least one of a DTX activation or deactivation, a DRX activation or deactivation, an NES conditional handover, an on-demand SSB transmission indication or termination, an SSB adaptation indication, or a PRACH adaptation indication.

In a sixth aspect, alone or in combination with one or more of the first through fifth aspects, the NES indication is transmitted via a common search space associated in accordance with an identifier associated with the NES indication.

In a seventh aspect, alone or in combination with one or more of the first through sixth aspects, process 1000 includes transmitting, to the UE, an LTM cell switch command associated with a cell switch from the first network node to a candidate network node of the one or more candidate network nodes, wherein the LTM cell switch command indicates at least one NES parameter associated with the candidate network node.

In an eighth aspect, alone or in combination with one or more of the first through seventh aspects, at least one NES parameter associated with the candidate network node includes at least one of a timeline for the cell switch in accordance with an active duration for a DTX or DRX associated with the candidate network node, a timeline for the cell switch in accordance with an on-demand SSB configuration or indication, an SSB adaptation configuration or indication, a PRACH adaptation configuration or indication, a beam associated with the cell switch in accordance with the on-demand SSB configuration or indication or the SSB adaptation configuration or indication, or a timeline for an LTM recovery procedure in accordance with the active duration for the DTX or DRX.

In a ninth aspect, alone or in combination with one or more of the first through eighth aspects, the NES indication includes at least one of an identifier associated with the one or more candidate network nodes or a bitmap indicating the one or more candidate network nodes.

In a tenth aspect, alone or in combination with one or more of the first through ninth aspects, the NES indication includes an indication of one or more NES features activated for the one or more candidate network nodes and a respective NES feature configuration for each activated NES feature of the one or more NES features.

In an eleventh aspect, alone or in combination with one or more of the first through tenth aspects, the NES indication includes a bitmap indicating the one or more NES features activated for the one or more candidate network nodes and one or more additional NES features deactivated for the one or more candidate network nodes, wherein an order of the respective NES feature configurations is in accordance with an order of the bitmap.

In a twelfth aspect, alone or in combination with one or more of the first through eleventh aspects, the respective NES feature configurations include at least one of a DTX configuration, a DRX configuration, an on-demand SSB configuration, an SSB adaptation configuration, or a PRACH adaptation configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 2-8. Additionally, or alternatively, the apparatus 1100 may be configured to perform one or more processes described herein, such as process 900 of FIG. 9. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive an NES indication that indicates one or more NES parameters associated with one or more candidate network nodes for LTM. The reception component 1102 or the transmission component 1104 may communicate one or more messages with the one or more candidate network nodes in accordance with the one or more NES parameters as part of a synchronization procedure for LTM. The transmission component 1104 may transmit, to a serving network node, a measurement report in accordance with one or more measurements associated with the one or more candidate network nodes, wherein the one or more measurements are performed in accordance with the synchronization procedure and the one or more NES parameters.

The reception component 1102 may receive, from the serving network node, one or more LTM candidate configurations associated with one or more NES feature configurations for the one or more candidate network nodes.

The reception component 1102 may receive, from the serving network node, a reconfiguration message that reconfigures at least one LTM candidate configuration of the one or more LTM candidate configurations in accordance with one or more updates associated with the one or more NES feature configurations or an additional NES indication associated with the one or more candidate network nodes.

The reception component 1102 may receive, from the serving network node, an LTM cell switch command associated with a cell switch from the serving network node to a candidate network node of the one or more candidate network nodes, wherein the LTM cell switch command indicates at least one NES parameter associated with the candidate network node.

The communication manager 1106 may perform an autonomous cell switch from the serving network node to a candidate network node of the one or more candidate network nodes in accordance with one or more conditions being satisfied, wherein the one or more conditions are satisfied in accordance with the NES indication or the one or more NES parameters.

The reception component 1102 may receive an indication of one or more TCI states activated in accordance with the NES indication, wherein the downlink synchronization is in accordance with the one or more TCI states.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 2-8. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The transmission component 1204 may transmit, to a UE, an NES indication that indicates one or more NES parameters associated with one or more candidate network nodes for LTM. The reception component 1202 may receive, from the UE, a measurement report in accordance with one or more measurements associated with the one or more candidate network nodes, wherein the one or more measurements are performed in accordance with the one or more NES parameters.

The reception component 1202 may receive, from a second network node, a message that includes the NES indication, wherein transmitting the NES indication to the UE is based at least in part on receiving the message.

The transmission component 1204 may transmit, to the UE, one or more LTM candidate configurations associated with one or more NES feature configurations for the one or more candidate network nodes.

The transmission component 1204 may transmit, to the UE, a reconfiguration message that reconfigures at least one LTM candidate configuration of the one or more LTM candidate configurations in accordance with one or more updates associated with the one or more NES feature configurations or an additional NES indication associated with the one or more candidate network nodes.

The transmission component 1204 may transmit, to the UE, an LTM cell switch command associated with a cell switch from the first network node to a candidate network node of the one or more candidate network nodes, wherein the LTM cell switch command indicates at least one NES parameter associated with the candidate network node.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving an NES indication that indicates one or more NES parameters associated with one or more candidate network nodes for LTM; communicating one or more messages with the one or more candidate network nodes in accordance with the one or more NES parameters as part of a synchronization procedure for LTM; and transmitting, to a serving network node, a measurement report in accordance with one or more measurements associated with the one or more candidate network nodes, wherein the one or more measurements are performed in accordance with the synchronization procedure and the one or more NES parameters.

Aspect 2: The method of Aspect 1, further comprising: receiving, from the serving network node, one or more LTM candidate configurations associated with one or more NES feature configurations for the one or more candidate network nodes.

Aspect 3: The method of Aspect 2, wherein the one or more NES feature configurations include at least one of a DTX configuration, a DRX configuration, an NES conditional handover configuration, an on-demand SSB configuration, an SSB adaptation configuration, or a PRACH adaptation configuration.

Aspect 4: The method of any of Aspects 2-3, further comprising: receiving, from the serving network node, a reconfiguration message that reconfigures at least one LTM candidate configuration of the one or more LTM candidate configurations in accordance with one or more updates associated with the one or more NES feature configurations or an additional NES indication associated with the one or more candidate network nodes.

Aspect 5: The method of any of Aspects 1-4, wherein the NES indication includes at least one of a DTX activation or deactivation, a DRX activation or deactivation, an NES conditional handover, an on-demand SSB transmission indication or termination, an SSB adaptation indication, or a PRACH adaptation indication.

Aspect 6: The method of any of Aspects 1-5, wherein the NES indication is received via a common search space associated in accordance with an identifier associated with the NES indication.

Aspect 7: The method of any of Aspects 1-6, further comprising: receiving, from the serving network node, an LTM cell switch command associated with a cell switch from the serving network node to a candidate network node of the one or more candidate network nodes, wherein the LTM cell switch command indicates at least one NES parameter associated with the candidate network node.

Aspect 8: The method of Aspect 7, wherein the at least one NES parameter associated with the candidate network node includes at least one of a timeline for the cell switch in accordance with an active duration for a DTX or DRX associated with the candidate network node, a timeline for the cell switch in accordance with an on-demand SSB configuration or indication, an SSB adaptation configuration or indication, a PRACH adaptation configuration or indication, a beam associated with the cell switch in accordance with the on-demand SSB configuration or indication or the SSB adaptation configuration or indication, or a timeline for an LTM recovery procedure in accordance with the active duration for the DTX or DRX.

Aspect 9: The method of any of Aspects 1-6, further comprising: performing an autonomous cell switch from the serving network node to a candidate network node of the one or more candidate network nodes in accordance with one or more conditions being satisfied, wherein the one or more conditions are satisfied in accordance with the NES indication or the one or more NES parameters.

Aspect 10: The method of Aspect 9, wherein the one or more conditions being satisfied include at least one of reception of an NES conditional handover indication associated with network node offloading, selection of a candidate network node in accordance with a switching execution timeline associated an active duration for a DTX or DRX associated with the candidate network node, or satisfaction of one or more measurement thresholds in accordance with an on-demand SSB configuration or indication, an SSB adaptation configuration or indication, or one or more resources associated with a PRACH adaptation configuration or indication.

Aspect 11: The method of any of Aspects 1-10, wherein the NES indication includes at least one of an identifier associated with the one or more candidate network nodes or a bitmap indicating the one or more candidate network nodes.

Aspect 12: The method of any of Aspects 1-11, wherein the NES indication includes an indication of one or more NES features activated for the one or more candidate network nodes and a respective NES feature configuration for each activated NES feature of the one or more NES features.

Aspect 13: The method of Aspect 12, wherein the NES indication includes a bitmap indicating the one or more NES features activated for the one or more candidate network nodes and one or more additional NES features deactivated for the one or more candidate network nodes, and wherein an order of the respective NES feature configurations is in accordance with an order of the bitmap.

Aspect 14: The method of any of Aspects 12-13, wherein the respective NES feature configurations include at least one of a DTX configuration, a DRX configuration, an on-demand SSB configuration, an SSB adaptation configuration, or a PRACH adaptation configuration.

Aspect 15: The method of any of Aspects 1-14, wherein the synchronization procedure includes a downlink synchronization in accordance with the NES indication, wherein the NES indication indicates at least one of an active duration associated with a DTX configuration for a candidate network node of the one or more candidate network nodes, an on-demand SSB transmission, or an SSB adaptation period.

Aspect 16: The method of Aspect 15, further comprising: receiving an indication of one or more TCI states activated in accordance with the NES indication, wherein the downlink synchronization is in accordance with the one or more TCI states.

Aspect 17: The method of any of Aspects 1-16, wherein the synchronization procedure includes an uplink synchronization in accordance with a timing advance that is based on the NES indication, wherein the NES indication indicates at least one of an active duration associated with a DTX or DRX configuration for the one or more candidate network nodes, an on-demand SSB transmission, or an SSB adaptation period.

Aspect 18: A method of wireless communication performed by a first network node, comprising: transmitting, to a UE, an NES indication that indicates one or more NES parameters associated with one or more candidate network nodes for LTM; and receiving, from the UE, a measurement report in accordance with one or more measurements associated with the one or more candidate network nodes, wherein the one or more measurements are performed in accordance with the one or more NES parameters.

Aspect 19: The method of Aspect 18, further comprising: receiving, from a second network node, a message that includes the NES indication, wherein transmitting the NES indication to the UE is based at least in part on receiving the message.

Aspect 20: The method of any of Aspects 18-19, further comprising: transmitting, to the UE, one or more LTM candidate configurations associated with one or more NES feature configurations for the one or more candidate network nodes.

Aspect 21: The method of Aspect 20, wherein the one or more NES feature configurations include at least one of a DTX configuration, a DRX configuration, an NES conditional handover configuration, an on-demand SSB configuration, an SSB adaptation configuration, or a PRACH adaptation configuration.

Aspect 22: The method of any of Aspects 20-21, further comprising: transmitting, to the UE, a reconfiguration message that reconfigures at least one LTM candidate configuration of the one or more LTM candidate configurations in accordance with one or more updates associated with the one or more NES feature configurations or an additional NES indication associated with the one or more candidate network nodes.

Aspect 23: The method of any of Aspects 18-22, wherein the NES indication includes at least one of a DTX activation or deactivation, a DRX activation or deactivation, an NES conditional handover, an on-demand SSB transmission indication or termination, an SSB adaptation indication, or a PRACH adaptation indication.

Aspect 24: The method of any of Aspects 18-23, wherein the NES indication is transmitted via a common search space associated in accordance with an identifier associated with the NES indication.

Aspect 25: The method of any of Aspects 18-24, further comprising: transmitting, to the UE, an LTM cell switch command associated with a cell switch from the first network node to a candidate network node of the one or more candidate network nodes, wherein the LTM cell switch command indicates at least one NES parameter associated with the candidate network node.

Aspect 26: The method of Aspect 25, wherein the at least one NES parameter associated with the candidate network node includes at least one of a timeline for the cell switch in accordance with an active duration for a DTX or DRX associated with the candidate network node, a timeline for the cell switch in accordance with an on-demand SSB configuration or indication, an SSB adaptation configuration or indication, a PRACH adaptation configuration or indication, a beam associated with the cell switch in accordance with the on-demand SSB configuration or indication or the SSB adaptation configuration or indication, or a timeline for an LTM recovery procedure in accordance with the active duration for the DTX or DRX.

Aspect 27: The method of any of Aspects 18-26, wherein the NES indication includes at least one of an identifier associated with the one or more candidate network nodes or a bitmap indicating the one or more candidate network nodes.

Aspect 28: The method of any of Aspects 18-27, wherein the NES indication includes an indication of one or more NES features activated for the one or more candidate network nodes and a respective NES feature configuration for each activated NES feature of the one or more NES features.

Aspect 29: The method of Aspect 28, wherein the NES indication includes a bitmap indicating the one or more NES features activated for the one or more candidate network nodes and one or more additional NES features deactivated for the one or more candidate network nodes, and wherein an order of the respective NES feature configurations is in accordance with an order of the bitmap.

Aspect 30: The method of any of Aspects 28-29, wherein the respective NES feature configurations include at least one of a DTX configuration, a DRX configuration, an on-demand SSB configuration, an SSB adaptation configuration, or a PRACH adaptation configuration.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

Aspect 38: A device comprising a processing system that includes one or more processors and one or more code-storing memories coupled with the one or more processors, the processing system configured to cause the device to perform the method of one or more of Aspects 1-30.

Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive a network energy saving (NES) indication that indicates one or more NES parameters associated with one or more candidate network nodes for Layer 1 or Layer 2 (L1/L2) triggered mobility (LTM);
communicate one or more messages with the one or more candidate network nodes in accordance with the one or more NES parameters as part of a synchronization procedure for LTM; and
transmit, to a serving network node, a measurement report in accordance with one or more measurements associated with the one or more candidate network nodes, wherein the one or more measurements are performed in accordance with the synchronization procedure and the one or more NES parameters.

2. The UE of claim 1, wherein the one or more processors are further configured to cause the UE to:
receive, from the serving network node, one or more LTM candidate configurations associated with one or more NES feature configurations for the one or more candidate network nodes.

3. The UE of claim 2, wherein the one or more NES feature configurations include at least one of a discontinuous transmission configuration, a discontinuous reception configuration, an NES conditional handover configuration, an on-demand synchronization signal block (SSB) configuration, an SSB adaptation configuration, or a physical random access channel (PRACH) adaptation configuration.

4. The UE of claim 2, wherein the one or more processors are further configured to cause the UE to:
receive, from the serving network node, a reconfiguration message that reconfigures at least one LTM candidate configuration of the one or more LTM candidate configurations in accordance with one or more updates associated with the one or more NES feature configurations or an additional NES indication associated with the one or more candidate network nodes.

5. The UE of claim 1, wherein the NES indication includes at least one of a discontinuous transmission activation or deactivation, a discontinuous reception activation or deactivation, an NES conditional handover, an on-demand synchronization signal block (SSB) transmission indication or termination, an SSB adaptation indication, or a physical random access channel (PRACH) adaptation indication.

6. The UE of claim 1, wherein the NES indication is received via a common search space associated in accordance with an identifier associated with the NES indication.

7. The UE of claim 1, wherein the one or more processors are further configured to cause the UE to:
receive, from the serving network node, an LTM cell switch command associated with a cell switch from the serving network node to a candidate network node of the one or more candidate network nodes, wherein the LTM cell switch command indicates at least one NES parameter associated with the candidate network node.

8. The UE of claim 7, wherein the at least one NES parameter associated with the candidate network node includes at least one of a timeline for the cell switch in accordance with an active duration for a discontinuous transmission or reception associated with the candidate network node, a timeline for the cell switch in accordance with an on-demand synchronization signal block (SSB) configuration or indication, an SSB adaptation configuration or indication, a physical random access channel (PRACH) adaptation configuration or indication, a beam associated with the cell switch in accordance with the on-demand SSB configuration or indication or the SSB adaptation configuration or indication, or a timeline for an LTM recovery procedure in accordance with the active duration for the discontinuous transmission or reception.

9. The UE of claim 1, wherein the one or more processors are further configured to cause the UE to:
perform an autonomous cell switch from the serving network node to a candidate network node of the one or more candidate network nodes in accordance with one or more conditions being satisfied, wherein the one or more conditions are satisfied in accordance with the NES indication or the one or more NES parameters.

10. The UE of claim 9, wherein the one or more conditions being satisfied include at least one of reception of an NES conditional handover indication associated with network node offloading, selection of a candidate network node in accordance with a switching execution timeline associated an active duration for a discontinuous transmission or reception associated with the candidate network node, or satisfaction of one or more measurement thresholds in accordance with an on-demand synchronization signal block (SSB) configuration or indication, an SSB adaptation configuration or indication, or one or more resources associated with a physical random access channel (PRACH) adaptation configuration or indication.

11. The UE of claim 1, wherein the NES indication includes at least one of an identifier associated with the one or more candidate network nodes or a bitmap indicating the one or more candidate network nodes.

12. The UE of claim 1, wherein the NES indication includes an indication of one or more NES features activated for the one or more candidate network nodes and a respective NES feature configuration for each activated NES feature of the one or more NES features.

13. The UE of claim 12, wherein the NES indication includes a bitmap indicating the one or more NES features activated for the one or more candidate network nodes and one or more additional NES features deactivated for the one or more candidate network nodes, and wherein an order of the respective NES feature configurations is in accordance with an order of the bitmap.

14. The UE of claim 12, wherein the respective NES feature configurations include at least one of a discontinuous transmission configuration, a discontinuous reception configuration, an on-demand synchronization signal block (SSB) configuration, an SSB adaptation configuration, or a physical random access channel (PRACH) adaptation configuration.

15. The UE of claim 1, wherein the synchronization procedure includes a downlink synchronization in accordance with the NES indication, wherein the NES indication indicates at least one of an active duration associated with a discontinuous transmission configuration for a candidate network node of the one or more candidate network nodes, an on-demand synchronization signal block (SSB) transmission, or an SSB adaptation period.

16. The UE of claim 15, wherein the one or more processors are further configured to cause the UE to:
receive an indication of one or more transmission configuration indicator (TCI) states activated in accordance with the NES indication, wherein the downlink synchronization is in accordance with the one or more TCI states.

17. The UE of claim 1, wherein the synchronization procedure includes an uplink synchronization in accordance with a timing advance that is based on the NES indication, wherein the NES indication indicates at least one of an active duration associated with a discontinuous transmission or reception configuration for the one or more candidate network nodes, an on-demand synchronization signal block (SSB) transmission, or an SSB adaptation period.

18. A first network node for wireless communication, comprising:
one or more memories; and
one or more processors, coupled to the one or more memories, configured to cause the first network node to:
transmit, to a user equipment (UE), a network energy saving (NES) indication that indicates one or more NES parameters associated with one or more candidate network nodes for Layer 1 or Layer 2 (L1/L2) triggered mobility (LTM); and
receive, from the UE, a measurement report in accordance with one or more measurements associated with the one or more candidate network nodes, wherein the one or more measurements are performed in accordance with the one or more NES parameters.

19. The first network node of claim 18, wherein the one or more processors are further configured to cause the first network node to:
receive, from a second network node, a message that includes the NES indication, wherein transmitting the NES indication to the UE is based at least in part on receiving the message.

20. The first network node of claim 18, wherein the one or more processors are further configured to cause the first network node to:
transmit, to the UE, one or more LTM candidate configurations associated with one or more NES feature configurations for the one or more candidate network nodes.

21. The first network node of claim 20, wherein the one or more NES feature configurations include at least one of a discontinuous transmission configuration, a discontinuous reception configuration, an NES conditional handover configuration, an on-demand synchronization signal block (SSB) configuration, an SSB adaptation configuration, or a physical random access channel (PRACH) adaptation configuration.

22. The first network node of claim 20, wherein the one or more processors are further configured to cause the first network node to:
transmit, to the UE, a reconfiguration message that reconfigures at least one LTM candidate configuration of the one or more LTM candidate configurations in accordance with one or more updates associated with the one or more NES feature configurations or an additional NES indication associated with the one or more candidate network nodes.

23. The first network node of claim 18, wherein the NES indication includes at least one of a discontinuous transmission activation or deactivation, a discontinuous reception activation or deactivation, an NES conditional handover, an on-demand synchronization signal block (SSB) transmission indication or termination, an SSB adaptation indication, or a physical random access channel (PRACH) adaptation indication.

24. The first network node of claim 18, wherein the NES indication is transmitted via a common search space associated in accordance with an identifier associated with the NES indication.

25. The first network node of claim 18, wherein the one or more processors are further configured to cause the first network node to:
transmit, to the UE, an LTM cell switch command associated with a cell switch from the first network node to a candidate network node of the one or more candidate network nodes, wherein the LTM cell switch command indicates at least one NES parameter associated with the candidate network node.

26. The first network node of claim 25, wherein the at least one NES parameter associated with the candidate network node includes at least one of a timeline for the cell switch in accordance with an active duration for a discontinuous transmission or reception associated with the candidate network node, a timeline for the cell switch in accordance with an on-demand synchronization signal block (SSB) configuration or indication, an SSB adaptation configuration or indication, a physical random access channel (PRACH) adaptation configuration or indication, a beam associated with the cell switch in accordance with the on-demand SSB configuration or indication or the SSB adaptation configuration or indication, or a timeline for an LTM recovery procedure in accordance with the active duration for the discontinuous transmission or reception.

27. The first network node of claim 18, wherein the NES indication includes at least one of an identifier associated with the one or more candidate network nodes or a bitmap indicating the one or more candidate network nodes.

28. The first network node of claim 18, wherein the NES indication includes an indication of one or more NES features activated for the one or more candidate network nodes and a respective NES feature configuration for each activated NES feature of the one or more NES features.

29. A method of wireless communication performed by a user equipment (UE), comprising:
receiving a network energy saving (NES) indication that indicates one or more NES parameters associated with one or more candidate network nodes for Layer 1 or Layer 2 (L1/L2) triggered mobility (LTM);
communicating one or more messages with the one or more candidate network nodes in accordance with the one or more NES parameters as part of a synchronization procedure for LTM; and
transmitting, to a serving network node, a measurement report in accordance with one or more measurements associated with the one or more candidate network nodes, wherein the one or more measurements are performed in accordance with the synchronization procedure and the one or more NES parameters.

30. A method of wireless communication performed by a first network node, comprising:
transmitting, to a user equipment (UE), a network energy saving (NES) indication that indicates one or more NES parameters associated with one or more candidate network nodes for Layer 1 or Layer 2 (L1/L2) triggered mobility (LTM); and
receiving, from the UE, a measurement report in accordance with one or more measurements associated with the one or more candidate network nodes, wherein the one or more measurements are performed in accordance with the one or more NES parameters.
